(19) United States
(12) Patent Application Publication
(10) Pub. No.: US 2025/0151012 A1
(43) Pub. Date: May 8, 2025

(54) SUPPORT FOR LOW POWER HIGH ACCURACY POSITIONING

(71) Applicant: InterDigital Patent Holdings, Inc., Wilmington, DE (US)

(72) Inventors: Jaya Rao, Montreal (CA); Faris Alfarhan, Montreal (CA); Fumihiro Hasegawa, Westmount (CA); Tuong Duc Hoang, Montreal (CA); Aata El Hamss, Laval (CA); Moon-il Lee, Melville, NY (US); Paul Marinier, Brossard (CA)

(73) Assignee: InterDigital Patent Holdings, Inc., Wilmington, DE (US)

(21) Appl. No.: 18/837,267

(22) PCT Filed: Feb. 9, 2023
(86) PCT No.: PCT/US2023/012669

§ 371 Date: Aug. 9, 2024

Related U.S. Application Data
(60) Provisional application No. 63/308,405, filed on Feb. 9, 2022.
(60) Provisional application No. 63/335,341, filed on Apr. 27, 2022.
(60) Provisional application No. 63/395,233, filed on Aug. 4, 2022.
(60) Provisional application No. 63/410,967, filed on Sep. 28, 2022.

(51) Int. Cl. H04W 64/00; H04L 5/00; H04W 76/20; H04W 76/30

(52) U.S. Cl. CPC H04W 64/00; H04L 5/0051; H04W 76/20; H04W 76/30

(57) ABSTRACT

Systems, methods, and instrumentalities are described herein for supporting low power high accuracy positioning (LPHAP). A wireless transmit/receive unit (WTRU) may receive configuration information (e.g., in a radio resource control (RRC) reconfiguration message) from a first cell. The configuration information may indicate a first sounding reference for positioning (SRSp) configuration and a second SRSp configuration. The first SRSp configuration may be associated with a first positioning area and the second SRSp configuration may be associated with a second positioning area. The first positioning area may include a first cell ID set and the second positioning area may include a second cell ID set. The first SRSp configuration may be activated and the second SRSp configuration may be deactivated.

### CROSS-REFERENCE TO RELATED APPLICATIONS

This application claims the benefit of Provisional U.S. Patent Application No. 63/410,967, filed Sep. 28, 2022, Provisional U.S. Patent Application No. 63/395,233, filed Aug. 4, 2022, Provisional U.S. Patent Application No. 63/335,341, filed Apr. 27, 2022, and Provisional U.S. Patent Application No. 63/308,405, filed Feb. 9, 2022, the disclosures of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein that may be associated with supporting low power high accuracy positioning (LPHAP).

A wireless transmit/receive unit (WTRU) may receive configuration information (e.g., in a radio resource control (RRC) reconfiguration message) from a first cell. The configuration information may indicate a first sounding reference for positioning (SRSp) configuration and a second SRSp configuration. The first SRSp configuration may be associated with a first positioning area and the second SRSp configuration may be associated with a second positioning area. The first positioning area may include a first cell ID set and the second positioning area may include a second cell ID set. The first SRSp configuration may be activated and the second SRSp configuration may be deactivated.

The WTRU may transmit a first SRSp using the first SRSp configuration. In examples, the WTRU may transmit the first SRSp based on detecting a cell ID that is in the first cell ID set. The first SRSp may be transmitted during a low power operation (e.g., an INACTIVE operation/state or idle operation/state) (e.g., based on receiving an RRCRelease message). The WTRU may select (e.g., detect) a second cell. In examples, the WTRU may select (e.g., detect) the second cell based on the WTRU detecting a cell ID of the second cell.

The WTRU may determine that the second cell is in the second positioning area. In examples, the WTRU may determine the second cell is located in the second positioning area based on the detected second cell ID being in the second cell ID set associated with the second positioning area. Based on the determination that the second cell is in the second positioning area, the WTRU may transmit a request to the second cell to activate the second SRSp configuration.

The WTRU may receive (e.g., from a second cell) an indication to activate the requested second SRSp configuration or an indication to activate a third SRSp configuration. The indication to activate may be received in a message (e.g., in an RRCResume message, an RRC reconfiguration message, or a MAC control element (MAC CE)) from the second cell. The WTRU may transmit an indication to deactivate the first SRSp configuration (e.g., when transmitting the request to activate the second SRSp configuration or in another indication request). The WTRU may transmit a second SRSp using the SRSp configuration indicated by the second cell (e.g., the requested second SRSp configuration or the third SRSp configuration).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates a WTRU in an INACTIVE state selecting a positioning area specific SRSp configuration for performing a SRSp transmission.

### DETAILED DESCRIPTION

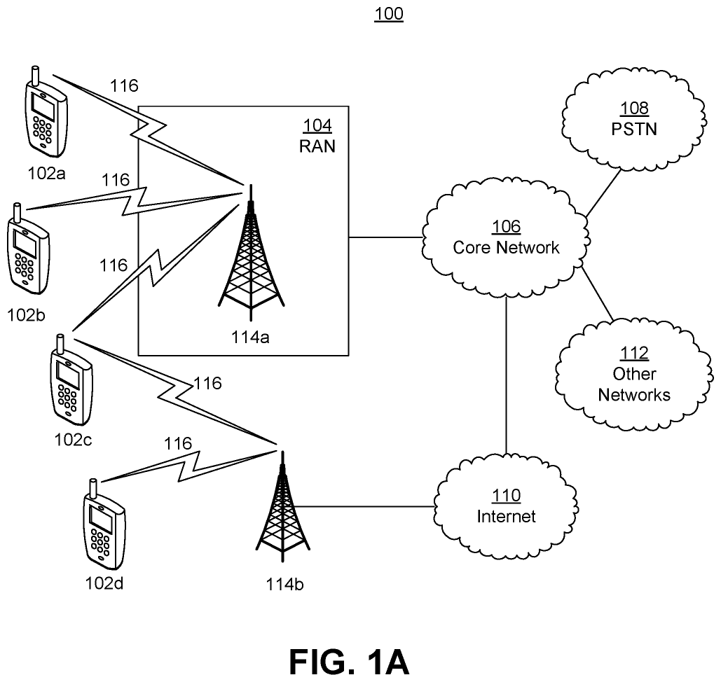

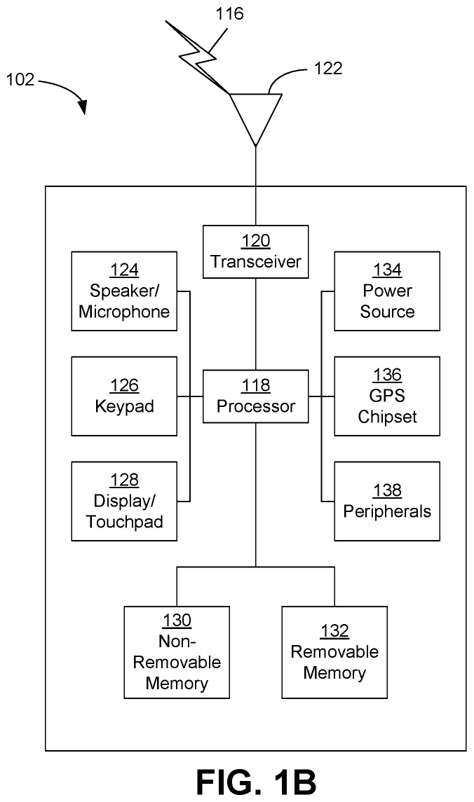

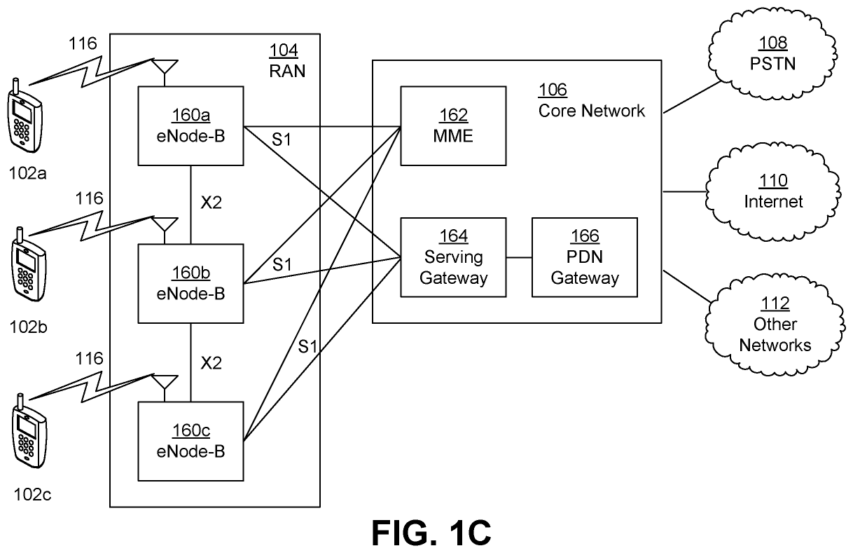

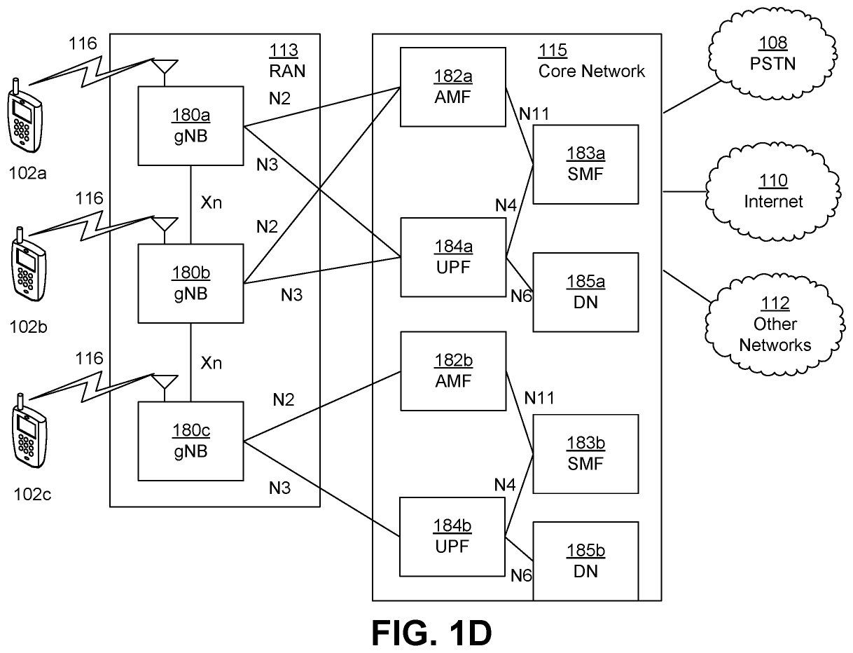

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHZ. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a timer expiration herein may refer to determining that the time has occurred or that the period of time has expired.

Systems, methods, and instrumentalities are described herein that may be associated with supporting low power high accuracy positioning (LPHAP).

A WTRU may receive configuration information (e.g., in a radio resource control (RRC) reconfiguration message) from a first cell. The configuration information may indicate a first sounding reference signal for positioning (SRSp) configuration and a second SRSp configuration. The first SRSp configuration may be associated with a first positioning area and the second SRSp configuration may be associated with a second positioning area. The first positioning area may include a first cell ID set and the second positioning area may include a second cell ID set. The first SRSp configuration may be activated and the second SRSp configuration may be deactivated.

The WTRU may transmit a first SRSp using the first SRSp configuration. In examples, the WTRU may transmit the first SRSp based on detecting a cell ID that is in the first cell ID set. The first SRSp may be transmitted during a low power operation (e.g., an INACTIVE operation/state or idle operation/state) (e.g., based on receiving an RRCRelease message). The WTRU may select (e.g., detect) a second cell. In examples, the WTRU may select (e.g., detect) the second cell based on the WTRU detecting a cell ID of the second cell.

The WTRU may determine that the second cell is in the second positioning area. In examples, the WTRU may determine the second cell is located in the second positioning area based on the detected second cell ID being in the second cell ID set associated with the second positioning area. Based on the determination that the second cell is in the second positioning area, the WTRU may transmit a request to the second cell to activate the second SRSp configuration.

The WTRU may receive (e.g., from a second cell) an indication to activate the requested second SRSp configuration or an indication to activate a third SRSp configuration. The indication to activate may be received in a message (e.g., in an RRCResume message, an RRC reconfiguration message, or a MAC control element (MAC CE) from the second cell. The WTRU may transmit an indication to deactivate the first SRSp configuration (e.g., when transmitting the request to activate the second SRSp configuration or in another indication request). The WTRU may transmit a second SRSp using the SRSp configuration indicated by the second cell (e.g., the requested second SRSp configuration or the third SRSp configuration).

A WTRU may perform LPHAP by operating in measurement mode and/or estimation mode. The WTRU may operate in a positioning estimation mode. The WTRU may send capability or assistance information for an estimation mode operation. The WTRU may receive assistance data for a LPHAP operation. The WTRU may switch between different positioning modes based on switching criteria. The WTRU may perform LPHAP if triggered with a paging message. The WTRU may send information on a LPHAP operation to a network.

Examples for supporting downlink (DL)-based LPHAP are provided herein. The WTRU may mitigate positioning errors with DL-based positioning if supporting LPHAP. The WTRU may perform LPHAP based on location dependent configuration(s) or resource(s). The WTRU may use DL-based positioned configuration information based on telecommunications relay services (TRS) reception. The WTRU may perform a prediction of a WTRU location to compensate for reduced DL measurement(s).

Examples for supporting uplink (UL)-based LPHAP are provided herein. The WTRU may perform uplink sounding reference signal for positioning (UL-SRSp) transmission(s) for LPHAP based on UL-configured positioning area(s). The WTRU may perform UL-based LPHAP based on location dependent configuration(s) or resource(s). The WTRU may use common SRSp resource(s) based on sensing. The WTRU may change or switch between SRSp configurations for supporting UL-based LPHAP based on a detecting of triggering event(s). The WTRU may transmit SRSp based on a detection of locations in a preconfigured positioning area. The WTRU may transmit SRSp based on a detection of a transmission (Tx) scheduled time occasion and triggering event(s).

Examples for supporting positioning with a Mobile Terminated Small Data Transmission (MT-SDT) are provided herein. A WTRU may be configured with MT-SDT for supporting positioning in a low power operation (e.g., an INACTIVE/IDLE state/operation/mode). The WTRU may receive indication(s)/information on positioning via an MT-SDT, for example, if operating in a Radio Resource Control (RRC) INACTIVE/IDLE mode. The WTRU behaviors/actions associated with positions may be based on whether an MT-SDT is configured or initiated. The WTRU may determine and send an indication to the network on attribute(s) of expected DL positioning information based on a configured MT-SDT. The WTRU may receive positioning information in a DL transmission based on a data volume threshold configured for an MT-SDT. The WTRU may send indication(s)/information on an RRC state and/or MO-SDT/MT-SDT configuration(s) to location management function (LMF) for supporting associated positioning procedure(s). The WTRU may receive an indication for using an MT-SDT configuration during mobility. The WTRU may receive assistance data or configuration(s) for positioning via an MT-SDT during mobility. The WTRU may be configured with a periodic positioning reference signal (PRS)/SRSp. The periodic PRS/SRSp may be associated with periodicities of discontinuous reception (DRX) cycles. The WTRU may determine the mode of reporting measurement(s) in an INACTIVE/IDLE state.

Examples for supporting DL and UL based LPHAP are provided herein. A WTRU may be configured to perform DL and UL positioning if in a low power operation (e.g., INACTIVE/IDLE state/operation/mode) based on triggering event(s). The WTRU may send positioning information to a network if operating in an INACTIVE state. The WTRU may send indication(s) to a network to assist with the prediction of the WTRU location if operating in an INACTIVE state. The WTRU may select a positioning area specific SRSp configuration based on the positioning area where the WTRU is located. The WTRU may send a request to update a validity condition of an SRSp configuration. The WTRU may select an SRSp configuration based on detectable TRPs. The WTRU may select an SRSp configuration based on an expected measurement accuracy in the positioning area where the WTRU is located.

In Low Power High Accuracy Positioning (LPHAP) use cases (e.g., industrial, utility, asset tracking), the location of the WTRU may be tracked while operating in a low power operation (e.g., an INACTIVE state/operation/mode and/or an IDLE state/operation/state) for a prolonged duration (e.g., 6 months to 1 year without charging/replacing battery). Minimizing signaling overhead and frequency of reporting positioning information/measurement(s) to a network or a network device may be desired (e.g., for power savings). If tracking the location of a WTRU, high positioning accuracy (e.g., with <1 m horizontal accuracy) may be achieved. For example, the high positioning accuracy may be achieved by minimizing signaling overhead and a frequency of reporting positioning information/measurement(s) to a network and by using interpolation techniques to estimate the WTRU location information. Interpolating the WTRU location information between the reports (e.g., the WTRU may send reports less frequently by including predictions) may leverage the survival concept for LPHAP where the location services (LCS) client/application may tolerate loss or no positioning reports or information. In LPHAP, the positioning of the WTRU with respect to an expected trajectory may be determined. This may be desired if, for example, the WTRU is mobile (e.g., attached to an asset, robot, etc.).

Examples provided herein support positioning during a low power operation (e.g., an INACTIVE/IDLE state/mode/operation) and during WTRU mobility that may result in balancing the tradeoff between achieving high accuracy and high-power savings.

A WTRU may be preconfigured with sounding reference signal for positioning (SRSp)/positioning reference signal (PRS) configurations for use during INACTIVE/IDLE state based on the awareness of the trajectory with which the WTRU is expected to use (e.g., on a factory floor). For UL-based positioning, the pre-configured SRSp may include a default SRSp configuration (e.g., low bandwidth (BW) and/or high accuracy SRSp configuration (e.g., high BW). A WTRU may select an SRSp configuration, for example, if and/or when triggered by one or more events. The one or more triggering events may include one or more of time (e.g., scheduled time occasions), positioning areas (e.g., a list of cells/TRPs), radio conditions, or positioning QoS (e.g., whether expected accuracy level is achieved). Power savings in a WTRU may be achieved by minimizing the occasions, duration, and bandwidth for transmitting one or more SRSp (for UL-based) and/or for performing PRS measurements/reporting (for DL-based). Power savings may be (e.g., may also be) achieved by not transmitting one or more SRSp/measuring PRS (e.g., if the accuracy requirement cannot be met) and using prediction/interpolation techniques.

Examples of a SRSp transmissions based on scheduled Tx occasions are provided herein. For a scheduled SRSp transmission, a WTRU may be configured with one or more scheduled Tx occasions for transmitting SRSp and SRSp configurations associated with Tx occasions. A WTRU may select a first SRSp configuration (e.g., a high periodicity configuration) for a SRSp transmission that results in high accuracy during the initial phase of positioning (e.g., when starting to move from stationary position) or if detecting an event indicating low accuracy. A WTRU may (e.g., may then) select a second SRSp configuration (e.g., a low periodicity configuration) in positioning phases (e.g., subsequent positioning phases) if the accuracy requirement is met and/or remains stable. If detecting an interruption event (e.g., a change in mobility state, reception of DL indication), the WTRU may reset a SRSp transmission procedure based on the type of event (e.g., which may help positioning accuracy and power savings).

A WTRU may receive configuration information. The configuration information may include one or more SRSp configurations. The SRSp configurations may include at least one or more resources in a first SRSp configuration (e.g., high periodicity SRSp configuration) and/or a second SRSp configuration (e.g., low periodicity SRSp configuration). The configuration information may include (e.g., may also include) one or more SRSp Tx occasions (e.g., T0, T1, T2) for transmitting one or more SRSp. A Tx occasion (Ti) may be associated with an SRSp configuration. During an initialization phase of positioning (e.g., at T0), the WTRU may start a timer that may run for a duration (e.g., a configured duration, T1−T0). The WTRU may select an SRSp configuration associated with the current SRSp Tx occasion (e.g., a WTRU may select a first SRSp configuration (high periodicity) if the current SRSp Tx occasion is T0 and may select a second SRSp configuration (low periodicity) if the current SRSp Tx occasion >T0). The WTRU may send an indication to a network, which may indicate the start of a SRSp transmission (e.g., when current Tx occasion is T0). The WTRU may transmit an SRSp using resources in the selected SRSp configuration. If an event (e.g., interruption event) is detected (e.g., reception of DL data/indication, change in mobility state), the WTRU may stop the timer and the transmission of the SRSp. If an event (e.g., a second event) is a semi-static event (e.g., reception of periodic data), the WTRU may restart the timer and restart the transmission of SRSp using current SRSp configuration (e.g., SRSp configuration associated with closest Tx occasion). If an event (e.g., a second event) is a dynamic event (e.g., reception of ultra-reliable and low latency communication (URLLC) data, change in mobility state), the WTRU may perform one or more of: reset the timer (e.g., to T0); send an indication to the NW, indicating reset and start of the SRSp transmission, or transmit the SRSp using resources in the SRSp configuration associated with the SRSp Tx time occasion (e.g., T0). If an event (e.g., a second event) corresponds to aborting a transmission (e.g., reception of DL indication to stop an SRSp transmission), the WTRU may stop the timer and the transmission of an SRSp. If an event (e.g., a second event) is not detected, the WTRU may stop an SRSp transmission at the expiration of the timer, for a configured duration, or until the start of a next Tx occasion.

Examples of an SRSp transmission based on a configured positioning area are provided herein. For an area-dependent transmission, the WTRU may transmit an SRSp at a preconfigured positioning area (e.g., a coverage area of set of TRPs) using an associated SRSp configuration. The WTRU may select a preconfigured SRSp configuration based on the trajectory the WTRU is expected to follow and based on the expected accuracy of measurements to be achieved at corresponding TRPs. If an expected accuracy requirement is not met at TRPs, the WTRU may use a SRSp (e.g., exceptional SRSp configuration with high BW) associated with some TRPs that can meet the accuracy.

The WTRU may receive configuration information. The configuration information may include one or more SRSp configurations, including at least resources in a low BW SRSp configuration and a high BW SRSp configuration (e.g., exceptional SRSp configuration). The configuration information may (e.g., may also) include one or more sets of TRPs (e.g., cell IDs). The one or more sets of TRPs may be associated with one or SRSp configurations (e.g., each set of the TRPs may be associated with an SRSp configuration) (e.g., TRPs in a set may be configured by LMF to make SRSp measurements). The configuration information may (e.g., may also) include a threshold for a minimum number of TRPs needed for meeting an accuracy requirement. The WTRU may perform SSB/TRS measurements to detect one or more transmission reception points (TRPs) and determine radio conditions associated with detected TRPs (e.g., using RSRP measurements of RSs in spatial relation with SRSp). If the detected TRPs match with a configured set of TRPs and/or if the number of detected TRPs with good reference signal received power (RSRP) are greater than the threshold for a minimum number of TRPs needed for meeting the accuracy requirement, the WTRU may select the low BW SRSp configuration associated with the detected TRPs and may transmit the SRSp using resources in low BW SRSp configuration. If the detected TRPs match with a configured set of TRPs and if the number of detected TRPs with a good RSRP is less than the threshold, the WTRU may perform one or more of the following: determine a high BW SRSp configuration (e.g., exceptional SRSp configuration) associated with detected TRPs with good RSRP based on pre-configuration and/or reception of positioning system information block (SIB); send an indication to a gNB (e.g., using RACH-SDT) indicating the IDs of detected TRPs and a request to activate the high BW SRSp configuration (e.g., exceptional SRSp configuration); or transmit an SRSp using resources in the high BW SRSp configuration (e.g., exceptional SRSp configuration) (e.g., after receiving an indication from gNB). If the detected TRPs do not match with a configured set of TRPs, the WTRU may send an indication to a gNB to request for updated SRSp configurations and may transmit the SRSp using resources in the updated SRSp configuration (e.g., after receiving the updated SRSp configuration from the gNB).

Downlink positioning examples, uplink positioning examples, and downlink and uplink positioning examples are provided herein.

In the downlink positioning examples, a WTRU may receive one or more PRSs from one or more TRPs. The WTRU may observe multiple reference signals and may measure a time difference of arrival between PRSs (e.g., a pair of PRS). The WTRU may (e.g., may then) send the measured reference signal time different (RSTD) to an LMF. The WTRU may send (e.g., in addition) measured RSRP(s) for PRS(s) (e.g., a measured RSRP for each PRS of the one or more PRSs). Based on the returned measurements, an LMF may conduct positioning of the WTRU. The WTRU may report RSRP for DL angle-based positioning.

An LMF is a non-limiting example of a node or entity (e.g., a network node or an entity) that may be used for or to support positioning. In examples, other nodes (e.g., any other node or entity) may be substituted for LMF.

In the uplink positioning examples, a WTRU may send an SRS for positioning (e.g., configured by an RRC) to reception points (RPs). For timing-based methods, a TRP may measure an RTOA for a received SRS and may report measured values to an LMF. The TRP may report an RSRP for an SRS. In the angle-based uplink positioning methods, an RP may measure angles of arrival and may report to an LMF.

In uplink and downlink positioning examples, a WTRU may measure a Rx-Tx time difference between a received PRS and a transmitted SRS. The Rx-Tx time difference may be reported to an LMF from the WTRU. The WTRU may (e.g., may also) report measured an RSRP for a PRS. At a TRP, a Rx-Tx difference between a received SRS and a transmitted PRS may be computed.

The following positioning examples are provided herein.

A “DL positioning example” may refer to any positioning example that uses downlink reference signals such as a PRS. The WTRU may receive one or more reference signals from a TP and may measure a DL RSTD and/or an RSRP. Examples of DL positioning are DL-AoD or DL-TDOA positioning.

An “UL positioning example” may refer to any positioning example that uses uplink reference signals such as SRS for positioning. The WTRU may transmit an SRS to multiple RPs and the RPs may measure the UL RTOA and/or RSRP. Examples of UL positioning may include UL-TDOA or UL-AoA positioning.

A “DL & UL positioning example” may refer to a positioning example that may use uplink and downlink reference signals for positioning. A WTRU may transmit an SRS to multiple TRPs and a gNB may measure a Rx-Tx time difference. The gNB may measure RSRP for the received SRS. The WTRU may measure a Rx-Tx time difference for a PRS transmitted from multiple TRPs. The WTRU may measure RSRP for the received PRS. The Rx-TX difference and/or RSRP measured at the WTRU and the gNB may be used to determine round trip time. A Rx and Tx difference may refer to the difference between arrival time of the reference signal transmitted by the TRP and transmission time of the reference signal transmitted from the WTRU. An example of DL & UL positioning is multi-RTT positioning.

“Network” may include AMF, LMF, base station, TRP, or gNB in NG-RAN.

Positioning examples for DL-PRS measurements in RRC CONNECTED may allow intra-gNB mobility (e.g., a limited level of intra-gNB mobility) (e.g., within coverage areas of TRPs belonging to the same gNB) and/or inter-gNB mobility (e.g., for scenarios where the same PRS configuration is used by multiple gNBs). The reporting of measurements or location information to the LMF may be supported via the serving gNB/cell.

Examples herein provide WTRU-based and LMF-based (e.g., WTRU-assisted) positioning for RAT-dependent and RAT-independent positioning. WTRU behavior and examples for supporting low power high accuracy positioning (LPHAP) (e.g., including examples related to configuration, transmission, measurements and reporting, low latency WTRUs, high power savings and high accuracy) may be provided herein. Examples of using LPP for determining the positioning information of WTRUs with LPHAP may be provided herein.

In DL based positioning examples, the WTRU may perform measurements of resources associated with DL-PRS. The WTRU may send measurement reports to an LMF based on assistance data provided by the network. In UL-based positioning examples, the WTRU may be configured with an SRS for positioning (SRSp) resources via RRC signaling. The transmission of the SRSp by the WTRU may (e.g., may then) be received by different TRPs/gNBs in the network for performing positioning measurements and reporting of the measurements to the LMF determining WTRU location. If the WTRU enters into a different coverage area including a set of TRPs/gNBs (e.g., updated/new TRPs/gNBs), the WTRU may be provided with PRS/SRSp configurations (e.g., updated/new PRS/SRSp configurations). This may result in wastage of resources and power inefficiency since the positioning examples (e.g., reception of configurations, transmission of SRSp, measurements of PRS) may be performed regardless of the power saving mode of WTRU, WTRU mobility attributes (e.g., stationary, or moving with low speed), and/or positioning QoS achievable (e.g., accuracy, latency).

Examples are provided herein of supporting positioning during a low power operation (e.g., an INACTIVE/IDLE state/operation/mode operation) and during WTRU mobility that results in balancing the tradeoff between achieving high accuracy and high-power savings.

A sounding reference signal for positioning may be denoted as “SRSp”. A PRS or SRS used herein is not limited to RS used for positioning. Examples herein may be applied to or used with (e.g., any) DL or UL reference signals. It should be noted that “SRSp” may refer herein to an SRS signal/transmission used for positioning. Resources for SRS for positioning (SRSp) may be defined (e.g., signaled) by RRC. A SRS resource set and SRS resource configured for positioning may be specified. “SRS for positioning” or “SRS” herein may include at least one of the following: SRS which may configured under SRS-PosResourceSet and SRS-PosResource; SRS which may be configured under SRS-ResourceSet and SRS-Resource; SRS which may not be configured under SRS-PosResourceSet and SRS-PosResource; SRS which may be not configured under SRS-ResourceSet and SRS-Resource; SRS which may be not associated with SRS-PosResourceSet, SRS-PosResource, SRS-ResourceSet or SRS-Resource; uplink reference signal that is associated for positioning; demodulation reference signal (DM-RS) for uplink; or phase tracking reference signal (PTRS) for uplink.

Positioning configuration examples are provided herein. A positioning configuration may include information related to positioning measurement and/or SRSp transmission. One or more of following information may be included in a positioning configuration: one or more of positioning examples used (e.g., DL-TDOA, UL-TDOA, DL-AOD, UL-AoA, Multi-RTT); a PRS configuration; an SRSp configuration; an uplink resource (e.g., physical downlink control channel (PRACH), physical uplink shared channel (PUSCH), physical uplink control channel (PUCCH) to report the positioning measurement; one or more threshold values to determine the positioning measurement quality; a positioning mode of operation (e.g., starting positioning mode of operation). A PRS resource configuration may include at least one of the following: a PRS resource ID; a PRS sequence ID, or other IDs used to generate a PRS sequence; a PRS resource element offset; a PRS resource slot offset; a PRS symbol offset; a PRS QCL information; a PRS resource set ID; a list of PRS resources in the resource set; a number of PRS symbols; a muting pattern for PRS, muting parameters such as repetition factor, muting options; a PRS resource power; a periodicity of PRS transmission; a spatial direction information of PRS transmission (e.g., beam information, angles of transmission); a spatial direction information of UL RS reception (e.g., beam ID used to receive UL RS, angle of arrival); a frequency layer ID; a TRP ID; or a PRS ID.

SRSp resources configurations may include at least one of the following: a resource ID; comb offset values, cyclic shift values; a start position in the frequency domain; a number of SRSp symbols; a shift in the frequency domain for SRSp; a frequency hopping pattern; a type of SRSp (e.g., aperiodic, semi-persistent, or periodic); a sequence ID used to generate SRSp, or other IDs used to generate an SRSp sequence; a spatial relation information, indicating which reference signal the SRSp is related to spatially; a resource set ID; a list of SRSp resources in the resource set; transmission power related information; pathloss reference information which may include an index for SSB, CSI-RS, or PRS; a periodicity of SRSp transmission; spatial direction information of an SRSp transmission (e.g., beam information, angles of transmission); or spatial direction information of DL RS reception (e.g., a beam ID used to receive DL RS and/or an angle of arrival).

As the part of the SRSp resources configuration, the WTRU may receive information related to the cell ID, global cell ID, or TRP ID. The received information may be associated with a PRS. The TRP that transmits the PRS may be identified by the TRP ID. The TRP ID may belong to a cell identified by the cell ID. The WTRU may be configured with timing information such as an SFN offset for a PRS or an SRSp transmission. The offset may prevent the WTRU from receiving an overlapping PRS in the time domain.

Examples for supporting general LPHAP are provided herein.

The WTRU may perform LPHAP by operating in measurement mode and/or estimation mode. A WTRU may operate in measurement mode and/or estimation mode, possibly for meeting positioning requirements associated with LPHAP services (e.g., low power, high positioning accuracy).

The WTRU operation in measurement mode may refer to one or more of the following: DL-based positioning; UL-based positioning; DL+UL based positioning; the areas and/or time occasions that may be associated with different reference locations and/or reference time instances at which the WTRU may perform measurements and/or transmission; or the WTRU may receive the area and/or time occasions from a network or application.

For DL-based positioning, measurements of DL signals (e.g., PRS, CSI-RS, SSB, TRS) for determining the position of the WTRU in one or more areas and/or at time occasions based on measurements made by the WTRU may be performed. DL-based positioning examples may include DL-TDoA, DL-AOD, etc.

For UL-based positioning, transmissions of UL signals (e.g., SRSp, SRS) for determining the position of the WTRU in one or more areas and/or at time occasions based on measurements made by TRPs/gNBs in a network may be performed. UL-based positioning examples may include UL-TDoA, UL-AoA, etc.

For DL+UL based positioning, a combination of DL-based and UL-based positioning (e.g., multi-RTT methods) for determining a position of a WTRU in different areas and/or at different time occasions may be performed.

For the WTRU receiving the area and/or time occasions from a network or application, the WTRU may receive the area and/or time occasions from the network or application possibly as configuration/assistance information, for example. The network may correspond to one or more of the following: one or more base stations (e.g., serving gNB or non-serving gNB in NG-RAN), TRPs associated with one or more base stations, LMF, AMF, or LCS client.

The WTRU operation in estimation mode may refer to one or more of the following. The WTRU operation in estimation mode may perform limited or no measurements of DL signals (e.g., DL-PRS, CSI-RS). The WTRU operation in estimation mode may perform limited or no transmissions of UL signals (e.g., SRSp, SRS). The WTRU operation in estimation mode may refer to the WTRU/NW using prediction/extrapolation techniques for determining a position of the WTRU at future areas and/or time occasions (e.g., p(T2)=p(T1)+v(T2−T1), where p is the position of WTRU and v is the velocity of the WTRU). The WTRU operation in estimation mode may refer to the WTRU/NW using smoothing/interpolation techniques for determining or correcting the position of the WTRU at previous/past areas and/or time occasions (e.g., p(T1)=p(T2)−v(T2−T1). The WTRU operation in estimation mode may refer to the prediction and/or smoothing techniques used to estimate the position of the WTRU. The WTRU operation in estimation mode may refer to the WTRU using internal sensors (e.g., accelerometers, gyroscopes, magnetometers) for measuring WTRU speed, direction, orientation and motion rate. The WTRU operation in estimation mode may refer to the WTRU performing sensor measurements periodically or if triggered by events (e.g., measurement/estimation errors if operating in a measurement mode above/below or more threshold values). The WTRU operation in estimation mode may refer to the WTRU supplementing the limited PRS measurement(s) and/or SRSp transmission(s) by performing sensor measurement(s) for saving power and/or for improving positioning accuracy. The WTRU operation in estimation mode may refer to the WTRU sending the information of WTRU location determined in estimation mode and/or by the sensor measurements to an LMF based on a reporting configuration received from an LMF (e.g., for WTRU-assisted or WTRU-based mode).

The prediction and/or smoothing techniques that may be used to estimate the position of the WTRU may be based on using one or more of the following: RAT dependent techniques (e.g., PRS measurements and/or SRSp transmissions), RAT independent techniques (e.g., GNSS measurements or sensor measurements), information on the mobility state of the WTRU (e.g., stop, mobile with first velocity, mobile with second velocity), or information of the trajectory of the WTRU (e.g., expected WTRU location at different time occasions).

Examples of the WTRU operating in a positioning estimation mode may be provided. The WTRU may operate in a measurement mode in a first time window/interval and operate in an estimation mode in a second time window. During the estimation mode, the location information of the WTRU in at least the second time window may be determined by the WTRU and/or network based on the expected change in the WTRU location with respect to the measurements made during the first time window.

During estimation mode, the WTRU may track the movement, mobility, and/or trajectory attributes of the WTRU with respect to the reference areas and/or time occasions for determining the position of the WTRU. The WTRU may perform measurements of a DL-PRS or a transmission of SRSp at an initial reference time. The WTRU may (e.g., may then) suspend performing measurements and/or transmissions during mobility, while tracking and/or logging the information related to movement/mobility attributes such as speed, direction, distance, and/or elapsed time since the previous reference time. The WTRU may perform DL-PRS measurements or UL-SRSp transmissions at the next reference time. The position of the WTRU at a time (e.g., any given time) may (e.g., may then) be determined or estimated by the WTRU or network based on the measurement information at one or more reference time instances and/or the tracking and/or logging information of mobility and/or trajectory attributes, for example.

Regarding an operation in an estimation mode for estimating, predicting, and/or smoothing the location information of the WTRU, a WTRU-assisted estimation mode and/or a WTRU-based estimation mode may apply.

For the WTRU-assisted estimation mode, the WTRU may send reports of measurements and/or the mobility attributes (e.g., speed, direction) to a network periodically, aperiodically, or when detecting an event trigger (e.g., possibly based on a assistance data received from network). The WTRU may transmit a UL-SRSp using a periodic, aperiodic, or semi-persistent SRSp resource configuration when detecting an event trigger (e.g., change in radio conditions, WTRU mobility state, trajectory, etc.). The position of the WTRU at different times may be estimated by the network by applying prediction, interpolation, and/or extrapolation techniques (e.g., to compensate for limited measurements or an absence of a complete set of measurements). The WTRU may send information on PRS measurements, change in trajectory attributes (e.g., change in WTRU movement with respect to expected trajectory/location known to network), error conditions, and/or prediction and/or smoothing information related to a WTRU location.

For the WTRU based estimation mode, the WTRU may receive assistance information from a network including one or more DL-PRS configurations and/or SRSp configurations, correction information for adjusting/compensating for errors in measurements, or reference areas and/or times where the WTRU may operate in measurement mode (e.g., perform DL-PRS measurements or UL-SRSp transmissions) or estimation mode (e.g., perform sensor measurements). The WTRU may switch between the measurement mode and the estimation mode periodically and/or if detecting events/conditions (e.g., RSRP of measurements is above/below an RSRP threshold, change in mobility state of WTRU). The WTRU may (e.g., may then) estimate the position of the WTRU at different time instances based on at least one of the assistance information, measurements, or sensor tracking information. The WTRU may send one or more indications to the network if switching between a measurement and an estimation mode. The WTRU may (e.g., may also) send information on at least one of: the location of the WTRU determined via (e.g., during) the estimation mode, errors in estimation, confidence level (e.g., in estimated location), or uncertainty in the determined WTRU location determined or measurements during estimation mode. The WTRU may send predicted location information (e.g., the location of the WTRU in geographic coordinate or relative position) or smoothed location information (e.g., corrected location information made in the past) based on the current measurements. The WTRU may associate a time stamp or a relative time stamp (e.g., a time difference between the current stamp expressed in terms of milliseconds, symbols, slots, frames, or subframes) with predicted or smoothed location information.

The WTRU may send capability and/or assistance information for an estimation mode operation. In examples, a WTRU may send capability and/or assistance information to a network (e.g., gNB or LMF) for operating in a positioning estimation mode if detecting one or more triggering events (e.g., as described herein). The WTRU may send the capability and/or assistance information semi-statically before and/or after initializing positioning procedure (e.g., LPP session) for determining a location of the WTRU, which may include an operation in a measurement mode or an estimation mode (e.g., prediction), for example. The WTRU may send capability/assistance information dynamically or on an on-demand basis at a time after initializing positioning procedure. The WTRU may send the capability/assistance information to the network in LPP messages (e.g., LPP provide capability info or LPP provide assistance info message) or AS layer signaling/messages (e.g., using one or more of RRC, MAC CE, uplink control information (UCI), or PUSCH).

The information sent by WTRU to the network, either as capability information (e.g., via LTE positioning protocol (LPP) capability transfer procedure, AS layer signaling/messages) or assistance information (e.g., via LPP assistance data transfer procedure, AS layer signaling/messages) may include one or more of the following: examples applied if operating in estimation mode; device attributes and/or parameters; accuracy achievable; reference locations, reference time instances, and/or trajectory; or information on power saving modes.

Examples applied if operating in an estimation mode may include one or more of the following. If operating in the estimation mode, the WTRU may indicate the capability to operate in a WTRU-assisted mode and/or a WTRU-based mode in association with the estimation mode. For example, the WTRU may indicate the ability to estimate a location of the WTRU, when operating in WTRU-based mode, with limited or without performing PRS measurements and/or SRSp transmissions. If operating in the estimation mode, the WTRU may indicate sensor/device information. For example, the WTRU may indicate the one or more identifiers and/or information associated with the sensors (e.g., gyroscope, magnetometer, accelerometer, GNSS receiver) which may be accessible by the WTRU for performing sensor measurements if operating in the estimation mode. If operating in the estimation mode, the WTRU may indicate technique/algorithm information. For example, the WTRU may indicate the identifiers and/or information on the positioning algorithms used (e.g., dead reckoning) with the internal sensors/devices for estimating the WTRU position. If operating in the estimation mode, the WTRU may indicate prediction and/or smoothing information. For example, the WTRU may indicate the IDs, information, configuration, and/or parameters related to the prediction techniques and/or algorithms applied for predicting the WTRU location based on limited or no measurements. Such techniques and parameters may include one or more of the capability for using neural networks (NN), learning techniques supported (e.g., supervised, unsupervised, reinforcement learning), training data parameters, the (e.g., maximum) number of layers in NN, the (e.g., maximum) number of neurons per layer, (e.g., maximum) number of inputs/outputs/weights per neuron, or processing latency.

For the device attributes and/or parameters sent from the WTRU to the network, the WTRU may provide information on at least one of: the number of antenna elements/panels, number of RF chains, antenna configuration information, bandwidth supported (e.g., per RF chain), or processing capability for transmission/reception, fusing RF measurements, and/or sensor measurements if supporting estimation mode.

For accuracy achievable information sent from the WTRU to the network, the WTRU may provide the one or more levels of positioning accuracy (e.g., per antenna element/panel, per-Rx/Tx RF chain, per sensor/device) that may be achievable if operating in the estimation mode and/or the measurement mode. The WTRU may indicate information on the timing error group (TEG) including WTRU Tx TEG IDs, WTRU Rx TEG IDs, WTRU Rx-Tx TEG IDs, for example. The WTRU may (e.g., may also) send the association information between SRSp resources and WTRU Tx TEG IDs, for example. The WTRU may indicate whether it is possible to operate (e.g., simultaneously operate) in the measurement mode and the estimation mode. The WTRU may indicate a confidence/weight/probability value (e.g., between 0 to 1) associated with operating in the measurement mode and/or the estimation mode. The confidence/weight/probability values may (e.g., may also) be associated with different granularities including one or more of RAT depended/independent techniques, positioning examples, PRS/SRSp configurations, frequency layers, resource sets/resources, beams, or sensor measurements. The WTRU may (e.g., may also) indicate the priority value and/or preferred value associated with the accuracy level.

For reference locations, reference time instances, and/or trajectory information sent from the WTRU to the network, the WTRU may provide information (e.g., identifiers) on availability and/or accessibility to one or more reference locations associated with positioning reference units (e.g., WTRUs, TRPs, gNBs, cells, NTN nodes, satellites) or (e.g., any) detectable landmarks (e.g., possibly in proximity with the WTRU). The WTRU may (e.g., may also) provide the distances/ranges to the identified reference locations, for example. The WTRU may (e.g., may also) indicate information (e.g., IDs) on one or more positioning areas and/or zones (e.g., possibly associated with the coverage area of one or more cells/TRPs/gNBs in which the WTRU was previously located, currently located, and/or expected to be located at different time instance).

For information on power saving modes sent from the WTRU to the network, the power saving modes supported by WTRU and/or configured by the network may be provided (e.g., possibly including the timing information (e.g., timestamp) for when the WTRU has previously transitioned into or is expected to transition into RRC CONNECTED, RRC INACTIVE, RRC IDLE, or any other combination of power savings modes/states). The information on power saving modes may include one or more configuration information or parameters associated with CDRX/DRX (e.g., cycle time on-duration, inactivity timer duration), for example. The WTRU may (e.g., may also) indicate the priority value and/or preferred value associated with power saving modes/states supported (e.g., possibly along with location/area information and/or timing information on where/when such priority/preferred values may apply).

Triggering events and/or conditions monitored by a WTRU for sending the capability information and/or assistance information on an LPHAP may include one or more of the following: reception of an indication or an LCS/LPP request from higher layers/application/network; detection reference locations and/or times; the periodicity of the trigger events and/or conditions; or a change in radio conditions or sensor measurements.

For reception of indication or LCS/LPP request from higher layers/application/network, the WTRU may send the capability information or indication if triggered by the LCS client/application in the WTRU (e.g., MO-LR) or in a network (e.g., MT-LR, deferred MT-LR, NI-LR). The LCS client/application may provide a reference time (e.g., a scheduled location time), reference locations, and/or an expected trajectory of the WTRU. The WTRU may receive the indication from the LCS client in one or more of the following: an LCS message, an LPP message, or AS layer signaling/channels (e.g., RRC, MAC CE, downlink control information (DCI), data, etc.). The WTRU may send capability and/or assistance information if receiving an LPP request message from the network. The request message may include a request for information related to measurements, WTRU power saving modes, trajectory, reference location/time, accuracy attributes, etc.

For detection reference locations and/or times, the WTRU may send the capability information and/or indication if detecting one or more reference locations (e.g., PRUs positioning areas) and/or at reference time instances (e.g., a scheduled location time).

For the periodicity of the trigger events and/or conditions, the WTRU may send the capability information and/or indication periodically (e.g., possibly based on one or more periodicity values configured by the network). The WTRU may send updated/new capability and/or assistance information if detecting changes (e.g., any change) in the capability and/or assistance information (e.g., with respect to previous occasion(s) when the information may be sent).

For a change in radio conditions or sensor measurements, the WTRU may send the capability information and/or indication if triggered by a change in the radio conditions detectable at the WTRU. The WTRU may be configured to perform measurements on DL-PRS/CSI-RS/SSB or sensor measurements. The WTRU may send the information if the measurement values (e.g., RSRP, received signal strength indicator (RSSI), magnetic field measurements, device orientation) increase or decrease by certain corresponding threshold values.

The WTRU may send an indication and/or information to network (e.g., gNB, LMF) (e.g., possibly based on the above triggering events/conditions). The indication and/or information sent by WTRU may include one or more of the following: capability information, a request for assistance information, a request for new/updated SRSp/PRS configuration, a request for activating a preconfigured SRSp/PRS configuration, an indication for informing a start of SRSp transmission or a start of PRS measurement, or an indication for the detection of a triggering event. The WTRU may send the indications in an RRC CONNECTED state, an RRC INACTIVE, or an RRC IDLE state. In examples, if the WTRU is in a low power operation (e.g., INACTIVE state/mode/operation), the WTRU may send the indication in an SDT using an RACH or CG resources associated with an SDT. In examples, if the WTRU is in IDLE state, the WTRU may send the indication in an initial access/RACH message (e.g., RRCRequest, RRCSystemInformation Request, RRCReconfiguration Request, or a RACH/RRC message associated with positioning). The WTRU may send the indication if in IDLE in an RACH occasion (e.g., possibly associated with positioning). If sending the indication in the INACTIVE/IDLE state, the WTRU may include a flag, information, and/or use resources associated with low power positioning (e.g., SDT), such that the WTRU may not be transitioned to a CONNECTED state. The WTRU may send the indication to a network if transitioning to a CONNECTED state (e.g., possibly for non-positioning or positioning related causes).

Examples of the WTRU receiving assistance data for LPHAP operation are provided herein. The WTRU may perform any procedures, functions, and operations associated with LPHAP if receiving assistance data associated with LPHAP and/or other positioning examples/schemes (e.g., DL-based, UL-based, DL+UL based, GNSS, etc.). The assistance data may be received in a positioning SIB (e.g., broadcasted with a configured periodicity in posSIB), LPP message(s), or AS layer signaling/channels (e.g., RRC, MAC CE, DCI, PDSCH, etc.).

The WTRU may receive the assistance data associated with an LPHAP due to (e.g., via) one or more of the following: sending a request, periodically, or detecting configured events and/or conditions.

For the WTRU receiving the assistance data associated with an LPHAP via sending a request, the WTRU may send a request for assistance data to a network (e.g., LPP message or AS layer signaling) indicating information, identifiers, configurations, and/or parameters associated with an LPHAP. The WTRU may (e.g., may then) receive the corresponding assistance data. In examples, the WTRU may receive the assistance data (e.g., in LPP message) after sending capability information and/or other indications/messages (e.g., on-demand request, LCS messages, LPP messages, positioning info/report, etc.).

For the WTRU receiving the assistance data associated with an LPHAP periodically, the WTRU may be configured by the network to receive assistance data periodically with a certain configured periodicity. The WTRU may request to change the periodicity for receiving assistance data based on detection of one or more events, such as a change in the mobility state of the WTRU (e.g., change from stop state to mobile state), or a change in trajectory.

For the WTRU receiving the assistance data associated with an LPHAP when detecting configured events and/or conditions, the WTRU may receive the assistance data for an LPHAP and/or other positioning methods/schemes (e.g., associated with different IDs) (e.g., which may be stored by the WTRU (e.g., in context info) and retrieved for future positioning procedures/sessions (e.g., LPP sessions). The WTRU may (e.g., may also) receive validity conditions (e.g., positioning area and/or time validity) and/or events associated with storing, using, and/or releasing the assistance data. The WTRU may use the preconfigured assistance data so long as the validity conditions are active/valid and/or no events invalidating the preconfigured assistance data are detected by the WTRU. The WTRU may receive updated/new assistance data if the validity conditions expire and/or events invalidating the preconfigured assistance data are detected by WTRU (e.g., possibly based on an indication sent by the WTRU to the network reporting the expiration of validity conditions, a detection of events, and/or a request for new/updated assistance data).

The assistance data received by a WTRU may include one or more of the following: a time window/interval for a measurement mode and/or an estimation mode; a measurement mode configuration (e.g., PRS configurations for LPHAP); an estimation mode configuration; a priority of measurements and/or estimation configurations; error thresholds (e.g., for determining whether an accuracy requirement is met); correction information (e.g., for recovering from measurement/estimation errors); or a reporting configuration.

For the assistance data received by a WTRU including a time window/interval for a measurement mode and/or an estimation mode, the WTRU may receive information on one or more time-windows and/or intervals (e.g., including start time slot/instance, offset time with respect to a reference time slot, time duration, stop time slot/instance) indicating when the WTRU may operate in the measurement mode (e.g., perform measurements of DL-PRS or transmission of SRSp) or operate in the estimation mode (e.g., perform sensor measurements, tracking of trajectory). The time windows may correspond to the information on when the WTRU may perform prediction/extrapolation and/or smoothing/interpolation of the WTRU location (e.g., when in the estimation mode). The WTRU may receive information on different time windows associated with a duration for performing measurements and/or using the measurements for performing prediction/extrapolation and/or smoothing/interpolation of a WTRU location. In examples, a first time window with a 10 ms measurement interval may be used for performing a prediction of an expected WTRU location for 1 ms ahead of time. In examples, a second time window with 5 ms measurement interval may be used for performing a prediction of an expected WTRU location for 0.5 ms ahead of time. The WTRU may receive information on the survival time, indicating the time window/interval which the LMF/LCS client/application may tolerate when there may be losses, delays, or no positioning reports and/or information sent by the WTRU. During the survival time, the WTRU/LMF may perform interpolation/smoothing for determining the WTRU location in the intermediate time instances between different positioning reports and/or information sent by the WTRU.

For the assistance data received by a WTRU including the measurement mode configuration (e.g., PRS configurations for LPHAP), the WTRU may receive one or more: PRS configurations and/or parameters (e.g., IDs); and/or SRSp configurations and/or parameters (e.g., which may be associated with or intended for LPHAP and/or power saving mode operation(s) (e.g., for use during INACTIVE/IDLE mode). The PRS/SRSp configurations may include one or more frequency layers, resources, resource sets, beams, or TRPs/gNBs associated with the indicated PRS/SRSp configurations. In examples, the one or more PRS/SRSp configurations for LPHAP may include a combination of a relatively low/high number of frequency layers, a bandwidth (frequency resources), a periodicity, a density of resources, a number of beams, a number of TRPs/gNBs, etc. The types of PRS/SRSp configurations received by the WTRU may include aperiodic, semi-persistent, and/or periodic, along with timing info associated with the different types such as a start time/slot, a periodicity, and/or a stop time/slot. The WTRU may (e.g., may also) receive information on one or more measurement gap configurations (e.g., IDs), which may be associated with the PRS configurations to be used during measurement mode(s) and/or estimation mode(s). Such measurement gap configurations may be activated during operation in measurement mode(s) and/or estimation mode(s).

For the assistance data received by a WTRU including the estimation mode configuration, the WTRU may receive trajectory information associated with the WTRU and/or another device (e.g., robot, asset, vehicle) which the WTRU may be attached to or co-located with. In examples, the trajectory information may correspond to one or more locations (e.g., coordinates) associated with different scheduled time instances (e.g., time 1: location 1, time 2: location 2, time 3: location 1). In examples, the trajectory information may include different trajectory types (e.g., straight path, curve left, curve right), which may be associated with different scheduled time instances. The trajectory information may be associated with one or more PRS/SRSp configurations (e.g., which may be used by the WTRU for performing measurements and/or transmissions if detecting the corresponding locations and/or time instances indicated in the trajectory).

The WTRU may receive one or more: trajectories (e.g., preconfigured), where each trajectory or subset of a trajectory may be associated with an ID; and/or information on which of the trajectory/subset of trajectory the WTRU is expected to use/follow (e.g., possibly at different time instances/windows). If reporting the information on the actual and/or estimated trajectory followed by the WTRU, the WTRU may send information on the trajectory/subset-of trajectory (e.g., IDs) to the network. For example, in the case when there may be uncertainty in the current or expected trajectories (trajectory/subset of trajectory) followed by the WTRU, the WTRU may determine one or more trajectories that may best match with the preconfigured trajectories received from network (e.g., difference between preconfigured and actual/expected trajectory, possibly in terms of locations on a path, is less than a threshold). The WTRU may indicate to the network information (e.g., IDs) on the determined trajectories, possibly along with confidence/weight/probability values associated with the different determined trajectories.

The WTRU may receive assistance data related to time windows indicating when the WTRU may operate in estimation mode. The assistance data may (e.g., may also) include the location information of cells/TRPs/gNB/positioning areas which may be expected to be detected by WTRU in a future time instances. Such information may be received and/or reported by the WTRU, in advance and/or when detecting the locations/time instances. This information reported by the WTRU on the detection of cells/TRPs may be used for assisting the network to improve the prediction accuracy of the WTRU location.

For the assistance data received by a WTRU including the priority of measurements and/or estimation configurations, the WTRU may receive priority values associated with a measurement mode and/or an estimation mode. Within each mode, the WTRU may (e.g., may also) receive priority values associated with PRS/SRSp configurations and/or trajectory configurations. The WTRU may select a mode and/or an associated configuration based on the order of priority, where the PRS/SRSp/trajectory configuration with the highest priority may be used first for measurements and/or estimation if multiple configurations are indicated/available.

For the assistance data received by a WTRU including error thresholds (e.g., for determining whether accuracy requirement is met), the WTRU may receive one or more error thresholds associated with measurements (e.g., RSRP threshold, number of multipaths) and positioning QoS (e.g., accuracy, integrity, latency). The error threshold values may be used by the WTRU for determining whether the positioning QoS requirements are met, for example, if determining/predicting/smoothing the WTRU location at different time instances.

For the assistance data received by a WTRU including the correction information (e.g., for recovering from measurement and/or estimation errors), the WTRU may receive correction and/or compensation information to apply if operating in a measurement mode and/or an estimation mode. The WTRU may (e.g., may also) receive correction and/or compensation information to apply if operating in a measurement mode and/or an estimation mode if recovering from error conditions if the measurements and/or estimation are invalid. In examples, the correction information may be related to timing/phase errors (e.g., associated with TRP/gNB, and/or PRS/SRSp resources), indicating the difference between the time instance/phase when the PRS/SRSp is generated and transmitted by the TRP/gNB or WTRU. In examples, the correction information may be related to timing/phase errors expected at different positioning areas and/or time instances. The WTRU may use the corresponding correction information based on one or more of the PRS/SRSp resources, TRP/gNB, area, time instance when performing measurements of PRS, transmission of SRSp, estimation, or prediction of the WTRU location.

For the assistance data received by a WTRU including the reporting configuration, the WTRU may receive reporting configuration to apply if sending the information on positioning measurements and/or positioning estimation/prediction (e.g., if operating in a measurement mode and/or an estimation mode). In examples, the reporting configuration may include the IDs to be used (e.g., LPP ID, WTRU ID, positioning examples/scheme ID, power saving mode ID). In examples, the reporting configuration may include whether to report absolute/averaged/min/max values related to measurements made on the PRS (e.g., resources/beams associated with PRS configuration(s)) and/or measurements made by sensors. The reporting configuration may include the reporting periodicities (e.g., whether reporting is to be aligned with measurements and/or transmissions), offsets with respect to start and/or end of measurements, and events that the WTRU may monitor/detect for sending reports to a network. The WTRU may send a report on positioning measurements, estimation, prediction, and/or uncertainty if one or more of the following are detected: a change in radio condition(s) (e.g., RSRP above/below a threshold), a change in mobility state, or a change in WTRU trajectory (e.g., a WTRU deviates from a straight path). The WTRU may include timing information (e.g., timestamps) in the reports (e.g., for indicating if the measurements and/or estimations are started/stopped). If the WTRU performs prediction/extrapolation and/or smoothing/interpolation, the WTRU may send the timing information (e.g., timestamps) related to start time, duration, and/or stop time associated with prediction/smoothing. If performing extrapolation/interpolation of the WTRU location, the WTRU may send information on the uncertainty of the prediction/smoothing, confidence value, and/or weight values associated with different instances of the extrapolated/interpolated location values.

The assistance data received by WTRU may be common across different positioning areas (e.g., including multiple cells/TRPs/gNBs) or specific to one or more cells/TRPs/gNBs. If the WTRU receives cell/TRP-specific assistance data (e.g., associated with ID of cell/TRP), the WTRU may use the associated assistance data if under the coverage of the cell/TRP.

The WTRU may receive an indication and/or information to a network (e.g., gNB, LMF) (e.g., possibly based one or more of the above triggering event(s)/condition(s). The indication and/or information received by WTRU may include one or more of the following: a request for capability info, a request for assistance info, assistance information, new/updated SRSp/PRS configurations, an activation/deactivation indication of one or more preconfigured SRSp/PRS configurations, an indication for initiating a start of an SRSp transmission or a start of a PRS measurement, or a confirmation/rejection indication for a request (e.g., any request) sent by WTRU. The WTRU may receive the indication(s) in an RRC CONNECTED state, an RRC INACTIVE, or an RRC IDLE state. In examples, if the WTRU is INACTIVE, the WTRU may receive the indication in a DL-SDT message (e.g., via an activated SDT configuration, DL-SDT RACH response, SPS-SDT, RRCRelease, etc.). In examples, if the WTRU is IDLE, the WTRU may receive the indication in an RRC message (e.g., RRCSetup, RRCReconfiguration, etc.) or a RACH response message. The WTRU may receive the indication in an updated SIB, which may be accessed by the WTRU after a certain configured time duration (e.g., expiration of a timer) if sending the indication to the network.

Examples of a WTRU switching between different positioning modes based on switching criteria are provided herein. The WTRU may switch between a measurement mode and an estimation mode based on detection of one or more conditions and/or triggering events in one or more switching criteria. The switching criteria may be received by the WTRU as assistance information semi-statically (e.g., as configuration) or dynamically from the network (e.g., in posSIB, LPP message, RRC signaling, MAC CE). The WTRU may send (e.g., in the case of dynamic reception) a request message (e.g., an on-demand request) and/or an activation indication for requesting to activate a preconfigured switching criteria.

The switching criteria for switching between the measurement mode and the estimation mode may be applied by the WTRU if detecting one or more of the following triggering events/conditions: measurement accuracy/integrity, an indication from a network/application/higher layer, a limitation in a PRS/SRSp configuration and an expiration of associated validity conditions, an error during estimation/measurement, a change in a power saving state, a change in a trajectory and/or mobility state, or a periodicity (e.g., detecting a timer).

For the WTRU detecting measurement accuracy/integrity, the WTRU may switch between modes if the determined positioning accuracy/integrity value is greater than or less than one or more accuracy/integrity threshold values (e.g., possibly received from the network). The WTRU may switch to a measurement mode when the accuracy associated with a sensor measurement is less than a threshold value.

For the WTRU detecting the indication from the network/application/higher layer, the WTRU may switch between modes if receiving an explicit or an implicit indication indicating to switch to a different positioning mode that is currently applied. The explicit indication received by the WTRU may include the identifier associated with the positioning mode (e.g., DL-PRS ID, UL-SRSp ID, estimation mode ID). The implicit indication received by WTRU for switching may include a paging message, a wake-up signal, a low-power triggering indication, Ran RC reconfiguration message, a PDCCH (DCI) indicating presence of data, triggering of SR/BSR for data transmission, etc. If receiving a wake-up signal, the WTRU may transition from the estimation mode to the measurement mode for performing DL-PRS measurement(s) or UL-SRSp transmission(s).

For the WTRU detecting the limitation in PRS/SRSp configuration(s) and expiration of associated validity condition(s), the WTRU may switch between modes if the number of TRPs, number of frequency layers, beams, resource sets, or amount of resources available via the PRS/SRSp configurations are greater than or less than one or more threshold values. If the WTRU detects that the number of TRPs from which it receives a PRS with a RSRP above a RSRP threshold value is below a threshold, the WTRU may switch to the estimation mode. If the validity conditions associated with PRS/SRSp configurations expire (e.g., TA timer expires, a change in RSRP of spatial relation RS is above/below threshold, the WTRU leaves a validity area, the expiration of a timer), the WTRU may switch to the estimation mode.

For the WTRU detecting the error during estimation and/or measurement, the WTRU may switch between modes if the estimation of the WTRU location based on sensor measurement or DL-PRS measurement is greater than or less than one or more error threshold values. The WTRU may switch to the estimation mode if receiving an explicit or an implicit indication from the network that the error due to an UL-SRSp transmission is below a threshold. In examples, the WTRU may switch to the estimation mode if the RSRP measurement of an RS (e.g., which is in spatial relation with a SRSp (e.g., DL-PRS, SSB)) is less than a threshold value.

For the WTRU detecting the change in the power saving state, the WTRU may switch between modes when transitioning between an RRC CONNECTED state, an RRC INACTIVE state, an RRC IDLE state, and/or any other power saving state.

For the WTRU detecting the change in trajectory and/or mobility state, the WTRU may switch between modes if (e.g., any of) the mobility states of the WTRU changes (e.g., stationary, speed levels in different speed ranges with different upper and low bounds). The WTRU may switch between modes if the trajectory of the WTRU changes (e.g., the WTRU location deviates by a certain threshold with respect to an expected location in an expected trajectory).

For the WTRU detecting the periodicity (e.g., detecting a timer), the WTRU may switch between modes periodically based on a configured/determined periodicity. The WTRU may use high/low switching periodicity based on change in the mobility state of WTRU (e.g., when the speed of WTRU increases above a threshold, the WTRU uses high switching periodicity, and the WTRU uses low periodicity when the speed is low or remains stable). The WTRU may switch between modes when a timer (e.g., with a configured duration) is set and/or expires.

If switching/changing from using a first set including one or more PRS/SRSp configurations to a second set of one or more PRS/SRSp configurations, triggering events/conditions (e.g., similar triggering event/conditions described above) may be applied. Such switching/changing between a PRS/SRSp configuration may be done if operating in a measurement mode and/or an estimation mode.

The WTRU may be preconfigured with one or more positioning QoS requirements (e.g., accuracy, latency, low power operation, integrity), where the different positioning QoS may be associated with different positioning modes (e.g., measurement/estimation modes), IDs, and/or priority values. If switching from a first mode to a second mode, the WTRU may use the positioning QoS associated with the second mode, possibly based on the order of priority associated with the positioning QoS. The WTRU may (e.g., may also) use a different reporting configuration if switching between different positioning modes.

The WTRU may operate partially in the measurement mode and the estimation mode if detecting one or more conditions and/or events described in the switching criteria. If detecting the availability of limited PRS configuration (e.g., limited number of TRPs with high RSRP, limited bandwidth), the WTRU may supplement/augment the limited measurements by operating (e.g., simultaneously operating) in the estimation mode (e.g., using sensor measurements). The WTRU may increase the time window/interval for operating in the estimation mode when determining limited PRS measurements, where the PRS measurements may be made over a reduced time window/interval.

The WTRU may be configured with an overall time window indicating the maximum/minimum time interval for performing measurements or estimation. The WTRU may determine switching time instances and/or the associated time intervals for operating in the measurement mode and/or the estimation mode within the configured overall time window. The WTRU may determine the switching time instance and/or intervals based on one or more conditions associated with measurement and/or estimation mode including the accuracy achievable, quality of measurements (e.g., high/low RSRP, number of multi-paths), presence of errors (e.g., timing/phase/sensor errors), or amount of power savings achievable.

In WTRU-based and/or WTRU-assisted modes, the WTRU may send an indication to the network (e.g., in LPP message, RRC signaling, MAC CE, UCI) if switching between measurement and/or estimation modes, possibly along with estimated/determined location information and/or measurements and timing information (e.g., timestamps) when switching. The WTRU may (e.g., may also) send in the indication the cause for switching (e.g., cause ID, event ID).

Examples of a WTRU performing an LPHAP based on trajectory information are provided herein. The WTRU may determine the location information if operating in a combination of a measurement mode and an estimation mode while ensuring positioning QoS (e.g., accuracy) requirements are met based on trajectory information. The WTRU may use the trajectory information for determining whether the location information of the WTRU determined via measurements and/or estimation is within the expected trajectory. The WTRU may (e.g., may also) use the trajectory information for performing corrections to the estimated WTRU location (e.g., if not performing measurements).

The WTRU may receive the trajectory information or a subset of the information (e.g., associated with the WTRU and/or another device/WTRU), which may be attached to the WTRU or in proximity with the WTRU, from the network/application (e.g., LCS client) in an LCS message, an LPP message, or AS layer signaling (e.g., RRC, MAC CE, DCI, etc.). The trajectory information may include a set of expected locations (e.g., coordinates) and/or expected time instances (e.g., scheduled location times) indicating where/when the WTRU may be located. The trajectory information may (e.g., may also) indicate where/when the WTRU may operate in the measurement mode and/or the estimation mode. The trajectory information may (e.g., may also) include different IDs, accuracy, and/or error parameters, which may be associated with the different locations and/or time instances indicated in the trajectory.

The WTRU may receive the trajectory information from the network (e.g., gNB, LMF). If the WTRU receives a request for trajectory from the network, the WTRU may send the trajectory information to the network. The trajectory information may include at least one of the following: trajectory of the movement (e.g., straight, curve), acceleration, velocity, direction of the movement (e.g., north, west, east, south, angle), or parameters required to represent the WTRU movement (e.g., dynamic model parameters such as velocity, acceleration, covariance matrix for noise in the model, parameters in the observation model, etc.).

If the WTRU receives or the WTRU is preconfigured with the trajectory information from the network, the WTRU may determine to use the information to perform prediction or smoothing (e.g., correct the past location estimation) of the location information for WTRU-based positioning. If the WTRU sends the location information, the WTRU may (e.g., may also) indicate to the network which model (e.g., identifier associated with model) the WTRU has used to make prediction or smoothing (e.g., straight trajectory was used to predict the future location information). The WTRU may (e.g., may also) indicate a prediction interval or a smoothing interval (e.g., a prediction of location N symbols/slots/frames/milliseconds ahead of time from the time the location information is reported, smoothed/interpolated location information N symbols/slots/frames/milliseconds prior to the time from the time the location information is reported) in the report.

The WTRU may include information associated with predicted or smoothed location at multiple time instances. The WTRU may include a future or past time stamp of the information associated with the predicted or smoothed location at one or more of the multiple time instances. The WTRU may (e.g., may also) include model information associated with predicted or smoothed location at each of the multiple time instances. The WTRU may include a predicted WTRU location information at T milliseconds, 2T milliseconds, and 3T milliseconds from the time stamp the WTRU includes in the measurement report. The WTRU may include associated predicted location information in the report (e.g., T, 2T and 3T milliseconds in the report).

The WTRU may indicate explicitly to the network that the model used to derive the location information (e.g., current, predicted, smoothed WTRU location) is the same as the model used in the last report. By indicating to the network that the model has not changed, the overhead for signaling may be saved.

Examples applied by a WTRU for LPHAP based on trajectory information may be as follows. The WTRU may receive the trajectory information (e.g., expected locations and/or time instances t0, t1, . . . ti) from a network. At time instance t0, the WTRU may perform measurements of DL-PRS over a configured time duration when operating in a measurement mode and determine its actual location. The WTRU may determine the difference/error between its determined actual location and the expected location at to indicated in the trajectory information. The WTRU may apply the error for correcting the actual location for calibration purposes. The WTRU may switch to operating in an estimation mode. At time instance t1, the WTRU may estimate its location when in the estimation mode (e.g., applying sensor measurements) based on previously determined actual location (e.g., at t0) and tracking of sensor measurements (e.g., speed, direction, number of instances where direction is changed, elapsed time for each instance since change in speed, and direction may be detected). If the WTRU detects an event and/or a condition for changing to the measurement mode (e.g., change in sensing accuracy, expiration of a timer, a periodicity), the WTRU may switch to the measurement mode and perform measurements of DL-PRS (e.g., possibly using the PRS configuration associated with the closest location and/or time instance indicated in the trajectory (e.g., t1). If the WTRU detects an event and/or a condition for changing to the measurement mode (e.g., change in sensing accuracy, expiration of a timer, a periodicity), the WTRU may determine its updated actual location based on the measurements and may determine the difference between the updated actual location and the estimated location. If the difference between the actual location and the estimated location is less than a threshold value, the WTRU may send an indication to the network indicating that its location is within the expected trajectory. If the difference between the actual location and estimated location is greater than a threshold value, the WTRU may send an indication to network indicating the error (e.g., difference in the location information) and/or a request for an updated trajectory. If no events are detected by the WTRU for changing to measurement mode, the WTRU may continue operating in the estimation mode up to the next time instance (e.g., t2).

Examples of the WTRU performing LPHAP if triggered with a paging message are provided herein. The WTRU may initiate an LPHAP by a triggering operation in a measurement mode (e.g., perform PRS measurements or a SRSp transmission) and/or an estimation mode (e.g., sensor measurement, prediction) based on reception of the paging message. The paging-based triggering for LPHAP may be intended to minimize or eliminate signaling associated with operation in an RRC CONNECTED state and establishing and/or maintaining connectivity with a serving cell/gNB. Such an approach may enable the WTRU to perform positioning procedures for prolonged durations if operating in power saving mode (e.g., in INACTIVE/IDLE state), for example. The paging message may be a paging message that is used for paging the WTRU if there is data to be sent in a DL or a paging message (e.g., with different ID) for positioning purposes.

The WTRU may receive configuration information (e.g., in assistance data) associated with one or more positioning areas, where each positioning area may include one or more cells/TRPs/gNBs. The positioning area may be associated with one or more identifiers and priority values. The positioning area may be associated/overlapping with one or more tracking areas (TAs) and/or RAN paging/notification areas (RNAs). For a DL-based approach, the TRP/gNBs in a positioning area may be associated with at least one PRS configuration, from which WTRU may receive the DL-PRS for measurements. Likewise, for an UL-based approach, the TRP/gNBs in a positioning area may be associated with at least one SRSp configuration, which may have been configured by the network for performing measurements of the SRSp transmitted by the WTRU. The paging message received by WTRU may be received from one or more TRPs/gNBs associated with the positioning area. The paging message information/identifiers may be associated with the positioning areas (e.g., which may be, may include, or may be associated with area IDs) in which the WTRU may perform DL-PRS measurements and/or UL-SRSp transmissions (e.g., in this case).

The WTRU may (e.g., may also) receive one or more DRX configurations associated with the positioning areas/TAs/RNAs, including the parameters associated with DRX cycle duration, DRX ON-duration, DRX inactivity timer, etc. The WTRU in a low power operation (e.g., INACTIVE/IDLE state/operation/state), may wake up according to an active DRX configuration to receive DL paging messages during the DRX ON-duration.

The paging message received by WTRU for triggering an LPHAP may include one or more of the following. The paging message may include identifiers associated with the WTRU (e.g., WTRU ID, C-RNTI, group ID, group-RNTI). The paging message may include information on identifiers/preamble to use if sending measurement reports and/or transmitting SRSp (e.g., the paging message may include the configuration info (ID) for the WTRU to apply when generating the preamble/WTRU ID and the WTRU may scramble the generated preamble/WTRU ID in the SRSp resource if transmitting SRSp). The paging message may include identifiers associated with PRS/SRSp configurations and/or parameters to apply (e.g., the WTRU may be preconfigured with one or more resources for PRS/SRSp and the WTRU may select the PRS/SRSp resources based on the associated ID received in the paging message). The paging message may include information on PRS/SRSp/RACH resources/configurations to use if performing measurements and/or SRS transmissions. The paging message may include information on the positioning mode to apply (e.g., measurement mode and/or estimation mode). The paging message may include information on the trajectory and/or a subset of a trajectory (e.g., ID) to apply/follow. The paging message may include information on timing for when to start/stop (e.g., offsets, duration, periodicities) for initiating PRS measurements, SRSp transmissions, and/or sensor measurement/tracking. The paging message may include information on a change in preconfigured PRS configurations/SRSp configurations, a change in positioning areas, and/or a change in scheduled location time.

If a paging message is received during a paging occasion, the WTRU may initiate the measurement mode (e.g., perform PRS measurements, transmit SRSp) and/or the estimation mode (sensor measurements, tracking) based on the information included in the paging message.

Examples of the WTRU sending information on LPHAP operations to a network are provided herein. The WTRU may send positioning information/indications/reports (e.g., location measurements/estimations), possibly related to LPHAP, to the network. In examples, the WTRU may send the positioning information on LPHAP based on a reporting configuration received in assistance data. In examples, the WTRU may send the positioning information/reports if detecting triggering events/conditions as described above (e.g., if receiving request from network, periodic reporting, switching from one more to another, detection of errors, etc.). Related to an UL-based LPHAP, the WTRU may send indications due to one or more of the following: if requesting for SRSp configurations and/or activation/deactivation of preconfigured SRSp configurations, if switching between different SRSp configurations, or if reporting the positioning information determined via an estimation mode.

The positioning information/reports related to LPHAP may be sent by the WTRU (e.g., periodically or in aperiodic fashion) based on event triggers, in at least one of the following: LPP messages or AS layer messages (e.g., RRC signaling, MAC CE, UCI, PUSCH data, etc.). The positioning information sent by the WTRU on LPHAP may include one or more of the following: location information, prediction/smoothing information, error information, achievable positioning QoS, or WTRU mobility/movement information.

For the location information, the WTRU may send the determined/estimated WTRU location (e.g., coordinates, relative location with respect to a reference location/landmark) and/or measurements used for determining/estimating the WTRU location. Such information may be sent along with the associated positioning mode applied (e.g., measurement mode and/or estimation mode) and timing information (e.g., timestamp). The WTRU may send information on sensor measurements made for estimating the WTRU location and/or measurements made on RRM signals (e.g., CSI-RS, SSB) (e.g., possibly in addition to the information on measurements made in DL-PRS). Such information may be used for improving the accuracy of the WTRU location.

For prediction/smoothing information, the WTRU may send the predicted/extrapolated location information (e.g., for future time instances) and/or the smoothed/interpolated location information (e.g., for previous time instances). The WTRU may send the timing information (e.g., timestamps) associated with prediction/smoothing during the time duration/window where the predictions/smoothing are applicable and/or performed by the WTRU and/or during instances related to when the predictions/smoothing are applicable and/or performed by the WTRU. The WTRU may (e.g., may also) indicate the confidence level and/or uncertainty associated with the predicted/smoothed location information.

For error information, the WTRU may (e.g., may also) indicate the errors due to time/phase/power/sensor measurements (e.g., timing/phase error group IDs), errors associated with prediction/smoothing if using measurement mode and/or estimation mode, and errors with respect to expected trajectory (e.g., the difference between an expected location and an estimated location).

For achievable positioning QoS, the WTRU may send information on the positioning QoS achievable (e.g., accuracy, integrity, latency, power savings), possibly with respect to the requirements and/or KPIs received from the network/application.

For WTRU mobility/movement information, the WTRU may send information on mobility states (e.g., stationary, mobile with low/high speed), other mobility/movement attributes (e.g., WTRU speed, direction, distance travelled in direct/straight path) and/or mobility path (e.g., a list of one or more cell/TRPs IDs traversed by WTRU over a time duration).

If operating in a low power operation (e.g., an INACTIVE/IDLE mode/state/operation), the WTRU may use small data transmission (SDT) or early data transmission (EDT) configurations for sending the positioning information/reports. The SDT/EDT configurations received by the WTRU from the network (e.g., serving gNB) may include information on the validity conditions for maintaining SDT/EDT (e.g., TA timer), (e.g., maximum) size of payload of messages, periodicities, and/or resource grants (e.g., SDT-configured grants), etc.

For minimizing the amount of reporting and transmission of positioning information during LPHAP operation, the WTRU may send the difference in the positioning information (e.g., delta) with respect to information sent in the previous reporting instances. Such differential reporting may (e.g., may also) be used by the WTRU if reporting the prediction/smoothing information of the WTRU location.

The different types of positioning information (e.g., location information determined via measurements/estimation, error info, etc.) may be associated with different priority values, where the priority values may possibly be received by the WTRU as assistance data from a network. The WTRU may (e.g., in this case) apply different reporting periodicities or urgency levels for sending the positioning information based on the priority associated with the information type to be reported. The positioning information, which may include a change value greater than a threshold with respect to previously reported information, may be sent with higher periodicity or triggered with higher urgency level (e.g., use a SR/BSR configuration associated with a high priority/URLLC traffic). The WTRU may send information related to errors and/or changes with respect to expected trajectory with higher periodicities and/or a higher urgency levels.

The WTRU may (e.g., may also) indicate or send a request message to the gNB to request to transition the WTRU from a low power operation (e.g., INACTIVE/IDLE state/mode/operation) to CONNECTED state operation if sending positioning information with high priority (e.g., greater than a threshold value). If detecting no or a low amount of estimation/prediction errors (e.g., less than a threshold), the WTRU may reduce the reporting periodicities by sending combined positioning information saved/stored from previous time instances.

A WTRU may be configured with a periodic PRS/SRSp. The periodic PRS/SRSp may be associated with periodicities of DRX cycles.

The WTRU may be configured with one or more DL PRS configurations/resources and/or UL SRSp resources. The one or more DL PRS configurations/resources and/or UL SRSp resources may include periodicity values that may be aligned with the periodicity of DRX cycles in a low power operation (e.g., INACTIVE and/or IDLE state/mode/operation).

The WTRU may be configured with DRX (e.g., I-DRX) if operating in the low power operation (e.g., INACTIVE state/mode/operation), where the periodicity of DL-PRS reception and/or UL SRSp transmissions may correspond to N multiples of the periodicity of the DRX cycles. For example, if N=5, the WTRU may receive PRS and/or transmit SRSp in every fifth DRX cycle. For example, if N=1, the WTRU may receive PRS and/or transmit SRSp in each DRX cycle. Such configuration(s) may allow the WTRU to perform reception and/or transmission of non-positioning signals (e.g., data, control, or paging messages) in the DRX cycles not associated with reception of PRS and/or transmission of SRSp. Such configuration(s) may (e.g., additionally) allow the WTRU to perform positioning measurements and/or transmissions less frequently compared to receptions/transmissions of other signals.

The periodicity of DRX cycles may correspond to K multiples of the periodicity of DL-PRS reception and/or UL SRSp transmissions. The DRX cycles may use fractional values (e.g., 1/N) for the periodicity of the DL-PRS reception and/or UL SRSp transmissions if the periodicity of DRX cycle corresponds to 1. If the periodicity of DRX cycles corresponds to K multiples of the periodicity of DL-PRS reception and/or UL SRSp transmissions, the WTRU may perform up to K PRS receptions and/or K SRSp transmissions in a DRX cycle.

The periodicity of DL-PRS reception and/or UL SRSp transmissions may be configured independent of the periodicity associated with the DRX cycles. If the WTRU (e.g., in this case) is configured with PRS and/or SRSp in one or more time slots/occasions that overlap with the active/on duration of a configured DRX cycle, the WTRU may perform PRS measurements and/or SRSp transmissions in the active duration as per the configurations. If the WTRU is configured with PRS and/or SRSp that are outside of the active/on duration of a configured DRX cycle, the WTRU may wake-up for one or more time slots/occasions for one or more of the following: monitoring signaling (e.g., any signaling) associated with positioning, receiving PRS, or transmitting SRSp.

The WTRU may be pre-configured with one or more periodicity values for PRS and/or SRSp. The WTRU may be (e.g., may also be) pre-configured with associated triggering conditions/events. The associated triggering conditions/events may be monitored by the WTRU for determining a suitable periodicity value to apply (e.g., if a triggering condition/event occurs, a respective periodicity value may be applied). In examples, the WTRU may be configured with first and second periodicity values for PRS and/or association information indicating the association with the DRX configurations configured in the WTRU. The WTRU may (e.g., in this case) use the first periodicity value for a PRS measurement (e.g., high periodicity with multiple PRS in a single DRX active duration) if a first DRX configuration (e.g., long DRX cycle) is applied. The WTRU may use the second periodicity value for a PRS measurement (e.g., low periodicity with PRS occurring after multiple DRX cycles) if a second DRX configuration is applied (e.g., short DRX cycle).

The WTRU may receive the periodicity configuration values for PRS and/or SRSp from a network (e.g., LMF and/or gNB) if in a CONNECTED state and/or if transitioning to a low power operation (e.g., an INACTIVE/IDLE state/mode/operation) (e.g., via a RRC release message). In examples, the WTRU may receive the periodicity configuration values for PRS/SRSp if in the low power operation (e.g., INACTIVE/IDLE state/mode/operation), via one or more of the following: MT-SDT, paging message, RRC message, MAC CE, or DCI. Such periodicity configuration values may be received by the WTRU from the network based on an information and/or an indication of a DRX configuration (e.g. periodicity, cycle duration, on/active time duration) and/or changes to the DRX parameters provided by the WTRU to the network.

Examples for supporting a DL-based LPHAP are provided herein. A WTRU may mitigate positioning errors with DL-based positioning if supporting LPHAP. The WTRU operating in a measurement mode and/or an estimation mode may provide (e.g., may ensure) low positioning error and high power savings if performing limited or no DL measurements (e.g., DL-PRS, CSI-RS, SSB). A positioning error may be caused by an error or an inaccuracy in determining the initial and/or reference location of the WTRU (e.g., possibly at a reference time instance). This may be due to errors as a result one or more of insufficient or inaccurate DL-based measurements (e.g., low bandwidth, low number of TRPs), errors in the hardware/devices (e.g., sensors applied), or errors in the radio environment (e.g., high number of multipaths, unavailability of LOS path). As a result of positioning errors at the initial/reference location, at times (e.g., each time instance) when the WTRU estimates the location (e.g., when in estimation mode) based on previous estimates and/or measurements, the error value may fluctuate, increase, and drift to the subsequent time instances when the estimates may be made.

For mitigating positioning errors, the WTRU may receive assistance data from a network/application including at least one of: one or more DL-PRS configurations (e.g., associated with different accuracy levels, amount of resources, priority, etc.); one or more trajectories and/or components/subsets of trajectories (e.g., with corresponding IDs) the WTRU are expected to follow; correction information for correcting the measurements made if determining a reference location of the WTRU; or one or more threshold values associated with positioning errors.

The WTRU may perform initial measurements on DL-PRS for determining the first reference location of WTRU at a reference time instance t0. The WTRU may provide (e.g., may ensure) high accuracy when determining the reference location by using at least one DL-PRS configuration associated with high accuracy (e.g., high bandwidth, high periodicity, high number of TRPs) and/applying correction information. The WTRU may receive one or more DL-PRS configurations (e.g., in posSIB or dedicated LPP signaling), which may be intended to be used by the WTRU based on one or more of: the type of location (e.g., reference location or intermediate location), time instance/duration, mobility state (e.g., stationary, mobile with low speed or less than a speed threshold, mobile with high speed or greater than a speed threshold), or expected accuracy level of prediction at which the measurements may be made for determining the WTRU location. For determining a reference location, the WTRU may select and/or use a first DL-PRS configuration or parameters associated with achieving high accuracy. For determining intermediate locations (e.g., any intermediate locations), the WTRU may use a second DL-PRS configuration or parameters associated with medium level accuracy. Selection (e.g., similar selection) of DL-PRS configurations and/or parameters may be performed by WTRU based on a mobility state. If selecting a DL-PRS configuration, the WTRU may indicate to the network (e.g., in on-demand request message or request to activate message) the selected configuration and/or parameters associated with the configuration (e.g., ID of configuration or parameters).

The WTRU may estimate and/or predict its expected location at a future time instance t1 based on the determined reference location and the expected trajectory. The WTRU may apply a prediction model for predicting the expected location at time instance t1, for example. The prediction model may include information related to aggregated and/or expected speed, direction, and an orientation of the WTRU at a different time instance between t0 and t1 (e.g., possibly indicated in the expected trajectory or determined by the WTRU based on tracking). The WTRU may operate in an estimation mode between t0 to t1, possibly for saving power by not performing or performing limited measurements on PRS. The WTRU may select (e.g., after reaching the expected location at t1) a suitable DL-PRS configuration (e.g., associated with the area where the WTRU may be located and/or mobility state of WTRU) and/or perform measurements of PRS for determining the actual location. The WTRU may (e.g., may also) use the measurements and/or tracking information determined during the estimation mode for determining the actual location at t1. In examples, the determined actual location may correspond to a second reference location.

The WTRU may (e.g., may then) determine the difference between the estimated/predicted location and the actual location at t1 for identifying errors in the prediction model, trajectory, and/or measurements. If the determined error is less than or equal to an error threshold value, the WTRU may apply the determined error as feedback information for correcting the prediction model, trajectory, and/or measurements. The WTRU may send an indication to the network with status information on the WTRU location and/or determined error. The WTRU may (e.g., may also) apply the error for correcting previous estimates of the WTRU location at the intermediate time instances, for example, between t0 and t1. If the determined error is greater than the error threshold value, the WTRU may send an indication to the network indicating information on the determined error, the WTRU location, a request for updated DL-PRS configurations, updated trajectory information, etc. The WTRU may (e.g., may also) reset the tracking of reference location and/or reference time instances (e.g., to t0) (e.g., possibly for using a DL-PRS configuration with different periodicity), based on the determined error level, for example. The WTRU may use a first DL-PRS configuration (e.g., with high periodicity) at the first reference location. The WTRU may (e.g., may then) use a second DL-PRS configuration (e.g., with low periodicity) at the second reference location if the error corresponding to the difference between estimated/predicted location and actual location (e.g., at or close to the second reference location) is less than a threshold value. Otherwise, if the error is greater than the threshold, the WTRU may use the first DL-PRS configuration (e.g., a high periodicity configuration) at the second reference location.

Examples of the WTRU performing LPHAP based on location-dependent configurations and/or resources are provided herein. The WTRU may perform LPHAP using DL-based configurations and/or resources which may be dependent on the positioning areas or zones overlapping with and/or in proximity to the coverage areas where the WTRU is located. The location dependent configurations and/or resources may be one or more DL-PRS configurations, parameters, and/or resources for transmitting reports/indications to the network in UL, which may be associated with different positioning areas. Each positioning area (e.g., in this case) may include one or more cells/TRPs/gNBs from which the WTRU receives DL-PRS for measurements and/or resource grants for reporting (e.g., if operating in a low power operation (e.g., INACTIVE/IDLE state/mode/operation). The different TRPs/gNBs may be common across different positioning areas or may be non-overlapping and/or specific to certain positioning areas.

The WTRU may receive the pre-configuration information on the association between one or more of the following: between positioning areas (e.g., area IDs), cells/TRP/gNBs (e.g., TRP IDs, PCIs), between DL-PRS configuration/resources (e.g., configuration/parameter IDs), or between UL resources for sending reports/indications (e.g., configured grants). The WTRU may (e.g., may also) receive area/time validity conditions, and/or information on the association between the validity conditions, between positioning areas, and between configurations/resources. Such association information may be received by the WTRU via posSIB (e.g., via a broadcast from one or more TRPs/gNBs in the positioning area), LPP messages, or AS layer messages (e.g., in RRC, MAC CE, DCI) (e.g., if the WTRU is in an RRC CONNECTED state). The association information may be stored in the WTRU or may be received when in an RRC INACTIVE/IDLE state (e.g., via SDT). The WTRU, which may be in proximity with one or more TRPs/gNBs in a positioning area, may select at least one DL-PRS configuration. The WTRU may use the selected configuration for performing measurements on PRS. Such a procedure for positioning may be supported by the WTRU when in RRC INACTIVE/IDLE states (e.g., possibly without having to establish a connection (e.g., any connection or signaling) with the network).

The WTRU may predict the DL-PRS configurations to apply at future locations and/or time instances based on the previous and/or current positioning area, association information between DL-PRS configurations and positioning areas, and the expected WTRU trajectory. The WTRU may determine the DL-PRS configurations to apply when entering into a positioning area (e.g., entering into a new positioning area when detecting a new cell/TRP/gNB IDs) based on the prediction. Such an approach may be useful for the WTRU to directly perform measurements using the determined/predicted DL-PRS configurations without having to receive additional SIB or establish connectivity with the network.

The different positioning areas may (e.g., may also) be associated with different DL-PRS configurations/parameters, which may be associated with different positioning QoS requirements (accuracy, latency, integrity, etc.) and/or radio conditions (e.g., RSRP measurements, LOS/NLOS, multipath, etc.). In examples, given a set of different DL-PRS configurations associated with a positioning area where the WTRU may be located, the WTRU may select a DL-PRS configuration or parameters from the set based on a positioning QoS expected to be achieved. The WTRU may select a DL-PRS configuration or parameters from a set based on whether the RSRP measurements and/or detection of multipaths made on a DL-PRS or an RS (e.g., which may be in spatial relation with the DL-PRS) are less/greater than one or more threshold values.

The different PRS configurations associated with a positioning area, received by the WTRU (e.g., in association/assistance information), may include at least two subsets of resources and/or parameters (e.g., periodicities, duration). The first and second subset may be within the same resource pool associated with a PRS configuration and/or may be from different resource pools (e.g., a first subset may be RRM resources and second subset may be DL-PRS), which may be in spatial/QCL relation with one and another. The first subset may be used by a WTRU for performing limited measurements during LPHAP operation (e.g., in measurement mode or estimation mode) and/or for determining the suitability of the associated DL-PRS for meeting a positioning QoS requirement. The resources and/or parameters in the first and second subset may be either overlapping or non-overlapping. For example, the first subset may include limited resources whereas the second subset may include the remaining and/or expanded resources associated with the PRS configuration. The amount/number of resources in the first subset may vary depending on the accuracy level achievable if using the corresponding DL-PRS configuration.

The first subset may have PRS resources which may be transmitted with a low periodicity value (e.g., 5 transmissions per subframe) whereas the second subset may have PRS resources which may be transmitted with a higher periodicity value (e.g., 20 transmissions per subframe). Prior to selecting a DL-PRS configuration, the WTRU may perform measurements (e.g., in this case) on the first subset for determining the quality of radio conditions (e.g., RSRP) and/or positioning information of the WTRU. The WTRU may (e.g., may then) determine whether to perform measurements on the second subset based on whether the determined quality of radio conditions is satisfactory (e.g., RSRP is greater/less than one or more threshold values) and/or the determined accuracy of WTRU positioning information is satisfactory (e.g., an error with respect to information determined via an estimation mode is less/greater than one or more threshold values).

The WTRU in the low power operation (e.g., an INACTIVE/IDLE state/mode/operation) may detect the PCI/cell ID from the SIB. The WTRU may receive the information on first subset (e.g., ID, resources) from an SIB or a pre-configuration based on the association between the PCI and first subset (e.g., possibly indicated in the SIB or other DL messages/signaling (e.g., LPP, AS layer)). The WTRU may perform initial measurements using resources in the first subset associated with one or more cells/TRPs. If the determined RSRP of measurements associated with one or more cells/TRPs are greater than a threshold, the WTRU may perform measurements using resources in the second subset for determining the positioning information. The measurements in the second subset may be intended for achieving higher positioning accuracy in the current or future location and/or time (e.g., with prediction/extrapolation). The measurements in the second subset may be intended for compensating low accuracy achieved in the previous locations and/or time instance (e.g., with smoothing/interpolation).

If the determined RSRP of measurements associated with one or more cells/TRPs are less than a threshold, the WTRU may supplement/compensate for the inadequate measurements with the estimations made by operating in an estimation mode (e.g., sensor measurements, trajectory tracking, prediction). The WTRU may send indications/reports to the network based one or more of: the selection of first and/or second subset of resources and/or parameters applied for measurements; a mode of operation applied (measurement/estimation mode); timing information (e.g., timestamps) indicating when first and/or second subsets are applied; or errors/accuracy determined when using first/second subsets.

Examples of a WTRU using a DL-based positioning configuration based on a TRS reception are provided herein. The WTRU may determine the DL-PRS configuration to apply based on a reception and/or a measurement of a tracking reference signal (TRS), possibly during LPHAP (e.g., operation in a measurement mode and/or an estimation mode). The TRS used for time-frequency synchronization may be realized using CSI-RS with a sparse configuration including a sparse set of resources/symbols. If operating in power saving mode (e.g., in an off duration during INACTIVE/IDLE state), the WTRU may wake-up periodically for measuring the presence of DL signals (e.g., primary synchronization signal (PSS), secondary synchronization signal (SSS), SSB, paging signals, wake-up signals/indications) (e.g., possibly for maintaining synchronization with a network). Such a procedure may be performed prior to when the WTRU may be able to receive DL-PRS for positioning measurements. However, waking-up (e.g., periodically waking-up) to detect/decode DL signals may result in (e.g., additional) power consumption and higher latency.

The WTRU in power saving mode (e.g., in a low power operation or in an INACTIVE state/mode/operation) may receive a TRS for performing time-frequency synchronization with the network prior to receiving DL-PRS for measurements. The WTRU may be configured with DRX in power saving mode. The WTRU may receive the TRS prior to the on-duration or paging occasion (e.g., with a configured offset duration with respect to the on-duration). The WTRU may perform PRS measurements (e.g., after quickly ensuring synchronization is maintained or re-established based on TRS measurements). For example, the WTRU may perform PRS measurements without having to incur latencies (e.g., additional latencies) associated with transmitting, receiving, and/or processing other signaling and measurements.

The PRS configuration that may be selected/applied by the WTRU for positioning measurements may depend on the type of TRS (e.g., different types of CSI-RS) available and/or the quality of TRS measurements. Depending on the type of PRS configuration that the WTRU intends to use for positioning, the WTRU may determine (e.g., in this case) whether synchronization may be achieved with a base station/gNB/TRP using the TRS. For using a PRS configuration with low bandwidth, the WTRU may perform initial synchronization with the TRS, and whereas for using PRS configuration with wide bandwidth (e.g., for high accuracy), the WTRU may perform synchronization with an SSB.

For supporting a TRS-based selection of a PRS configuration, the WTRU may receive association and/or assistance information indicating the combination of association and/or mapping relation between one or more DL-PRS configurations, TRS configurations, threshold values for selecting PRS configurations based on TRS, mobility states of WTRU, positioning areas (e.g., cells/TRPs/gNBs), or reference locations and/or time instances. Such association information may be received by the WTRU via an SIB, LPP signaling, or AS-layer signaling (e.g., RRC, MAC CE, DCI, PDSCH, etc.) if operating in different RRC states. The association information may be received by the WTRU via a paging message, an on-demand SIB, or an on-demand PRS message. The association and/or assistance information may (e.g., may also) indicate that the WTRU may expect to receive the PRS after a certain number of slots/symbols after receiving a TRS. For different associations between TRS configurations and PRS configurations, the number of slots/symbols may vary for which the WTRU may expect to receive the PRS after receiving the TRS.

A positioning area may be associated with one or more TRS configurations on a per-cell/TRP/gNB basis. The different TRS configurations may (e.g., may also) be associated with one or more PRS configurations with different bandwidth/resources. The WTRU in a positioning area may determine the PRS configuration to apply for positioning based on the measurements made on the associated TRS.

Examples of a WTRU performing predictions of WTRU locations to compensate for reduced DL measurements are provided herein. The WTRU may supplement the lack of measurement information if operating in power saving mode (e.g., INACTIVE/IDLE state/mode/operation) by sending reports to the network on the predicted WTRU location information determined by operating in an estimation mode. In examples, the WTRU may receive configuration information and/or assistance data. The configuration information and/or assistance data may include at least one of the following: trajectory information (e.g., straight path, left curve, right curve, or parameters that describe motion/movement of the WTRU); timing information for prediction/smoothing (e.g., scheduled time occasions (e.g., T0, T1, T2, . . . ), prediction intervals (D1) for determining future WTRU locations, and smoothing intervals (D2) for determining intermediate WTRU locations); one or more threshold values associated with a prediction error (e.g., the difference between actual location and predicted/estimated location); or a reporting configuration that may include the time occasions when the WTRU is expected to send positioning information to the network.

The WTRU may send information on the initial trajectory (e.g., movement in straight path). The WTRU may receive the PRS configuration and/or resources associated with the reported trajectory, which may be applied during a measurement mode and/or an estimation mode. At a first time occasion (e.g., T0), the WTRU may perform PRS measurements using the received PRS configuration and/or resources. The WTRU may perform a prediction of the WTRU location at different prediction intervals (D1) up to a second time occasion (e.g., T1) based on an operation in an estimation mode and/or trajectory information. At the second time occasion (e.g., T1), the WTRU may perform PRS measurements using the received PRS configuration. The WTRU may determine the actual WTRU location at the second time occasion based on the measurements. The WTRU may (e.g., may then) determine the prediction error (e.g., the difference between the actual WTRU location and estimated WTRU location at T1). If the prediction error is less than a first threshold value, the WTRU may determine the WTRU location information in the intermediate instances and/or locations for the smoothing intervals between the first and second time occasion (e.g., possibly using a smoothing/interpolation technique). The WTRU may send the estimated WTRU locations, in the smoothing intervals between the first and second time occasion (e.g., in the subsequent reporting occasion). The WTRU may send the estimated/predicted WTRU location, possibly when detecting another triggering event (e.g., a change in a WTRU trajectory or change in mobility state). If the prediction error is greater than a first threshold value and/or less than a second threshold value, the WTRU may apply certain adjustments to the prediction/smoothing model applied in the estimation mode and/or may perform corrections to the estimated WTRU locations in the intermediate instances and/or locations for determining corrected WTRU location information. The WTRU may (e.g., may then) send the corrected estimated WTRU location information to the network. If the prediction error is greater than the second threshold value, the WTRU may send the actual position information determined at second time occasion via measurements of DL-PRS. The WTRU may (e.g., may also) send an indication to request for an updated configuration and/or assistance data for timing information (e.g., new timing information) for prediction/smoothing and/or a PRS configuration (e.g., an updated PRS configuration with high bandwidth, high density).

The WTRU may determine the mode of reporting measurements in a low power operation (e.g., INACTIVE/IDLE state/mode/operation). The WTRU may determine what to include in a measurement report and/or how to send measurement reports, for example, if performing DL-based positioning if in the INACTIVE/IDLE state (e.g., this may potentially minimize the number/amount of transmissions and/or improve power savings for LPHAP at the WTRU). The WTRU may be configured to perform DL-PRS measurements if operating in the INACTIVE/IDLE state using one or more of the following modes of reporting if sending measurement reports to network: staggering measurements, skipping or resuming reporting, differential reporting, or dropping of measurements.

For staggering measurements, a WTRU may be configured to perform RSRP/RSTD measurements of a PRS received over one or more periods/occasions. The WTRU may stagger the one or more measurements over M occasions before transmitting the measurements. In examples, the number of occasions M to stagger the measurements may be pre-configured in the WTRU. In examples, the number of occasions M to stagger the measurements may be determined by the WTRU based one or more factors including: expiration of a timer, or an amount of increase/decrease in RSRP/RSTD measurement values with respect to previous/reference measurements.

For skipping or resuming reporting, the WTRU may (e.g., if the WTRU is configured to perform measurements of a DL-PRS) decide to skip sending one or more measurement reports (e.g., if the change in the measurements made with respect to a previous/reference measurement is below a threshold value (e.g., RSTD/RSRP difference threshold)). The WTRU may resume sending measurement reports if the change in the measurements made with respect to a previous/reference measurement is above a threshold value.

For differential reporting, a WTRU may (e.g., if the WTRU is configured to report PRS measurements and/or location estimations) report the difference or delta with respect to a reference location and/or a reference time instance. The reference location may correspond to a location of the WTRU at an earlier time instance or a location of a landmark/anchor point. The reference time instance may correspond to a starting, initialization, or triggering time instance tracked by the WTRU. If performing differential reporting, the WTRU may report to a network the information on the reference point/time (e.g., an ID or a location of a reference point) and/or the difference with respect to the location and/or measurements made/expected at the reference point/time.

For the dropping of measurements, the WTRU may drop one or more measurements or estimations if one or more of the following conditions are met: an expiration of a configured timer, a prioritization of a report is low, a detection of a positioning error, a drop in positioning accuracy, a drop in battery capacity (e.g., below a threshold value), or an increase in Tx power for transmitting the report.

If sending measurement reports after performing DL-based positioning in a low power operation (e.g., INACTIVE/IDLE state/mode/operation), the WTRU may include timestamps for indicating one or more of the following: timings corresponding to when the measurements or estimations were made or timings corresponding to switching between one mode of reporting to another.

The WTRU may send positioning information to a network if operating in a low power operation (e.g., INACTIVE state/mode/operation). The WTRU in the INACTIVE state may determine whether to transmit or skip reporting positioning information to a network based on the determined prediction error. In examples, the WTRU may be configured to perform at least one of the following. The WTRU may receive configuration information from a network (e.g., in a RRCRelease message). The configuration information may include one or more PRS configurations, time occasions (e.g., T1, T2) for sending positioning reports, and/or a prediction error threshold (e.g., a difference between an actual location and a predicted location). The WTRU may receive from higher layers, mobility attributes of the WTRU (e.g., the WTRU speed and/or direction of movement). The WTRU may perform a first PRS measurement at first time occasion (T1) and determine a WTRU location at T1. The WTRU may determine a predicted WTRU location at second time occasion based on the determined first WTRU location and the mobility attributes. The WTRU may transmit a positioning report to a network including the determined WTRU location at T1 and a predicted WTRU location at T2. The WTRU may perform a second PRS measurement at a second time occasion (T2) and determine a WTRU location at T2. The WTRU may determine a prediction error based on the determined WTRU location and the predicted WTRU location at T2. The WTRU may, if the prediction error is less than the threshold value, skip transmission of a positioning report at T2. The WTRU may, if the prediction error is greater than the threshold value, transmit a positioning report to a network including the determined WTRU location at T2.

The WTRU may send indications to a network to assist with the prediction of the WTRU location if in a low power operation (e.g., operating in an INACTIVE state/mode). The WTRU in the INACTIVE state may determine whether to send an ACK indication or a measurement report to a network based on the determined prediction error. In examples, the WTRU may be configured to perform at least one of the following. The WTRU may receive configuration information from a network (e.g., in a RRCRelease message) including one or more PRS configurations, time occasions (e.g., T1, T2) for sending positioning reports, and/or a prediction error threshold (e.g., a difference between an actual location and a predicted location). The WTRU may receive from higher layers, a first set of mobility attributes of the WTRU (e.g., the WTRU speed and/or direction of movement). The WTRU may perform a first PRS measurement at a first time occasion (T1) and determine a WTRU location at T1. The WTRU may transmit a positioning report to a network including the determined WTRU location at T1 and the first set of mobility attributes. The WTRU may receive from a network a predicted WTRU location at T2. The WTRU may receive from higher layers, a second set of mobility attributes of the WTRU (e.g., the WTRU speed and/or direction of movement). The WTRU may perform a second PRS measurement at a second time occasion (T2) and determine the WTRU location at T2. The WTRU may determine a prediction error based on the determined WTRU location and the predicted WTRU location at T2. The WTRU may, if the prediction error is less than the threshold value, transmit an ACK message to the network (e.g., for indicating the prediction at the network is valid). The WTRU may, if the prediction error is greater than the threshold value, transmit a positioning report to the network including (e.g., any of) the determined WTRU location at T2 and the second set of mobility attributes.

Examples for supporting a UL-based LPHAP are provided herein. A WTRU may transmit UL-SRSp transmissions for LPHAP based on UL-configured positioning areas. The WTRU may transmit a SRSp using one or more SRSp configurations and/or resources (e.g., periodic, aperiodic, semi-persistent) which may be applicable over different UL-configured positioning areas while operating in a power saving mode during mobility. The UL-configured positioning areas may include one or more cells/TRPs/gNBs that may be configured to perform measurements on the SRSp transmitted by the WTRU. The different positioning areas to which the WTRU may traverse as per the WTRU trajectory may be associated with different SRSp configurations. The WTRU may use resources from an SRSp configuration for SRSp transmission based on the positioning area/validity area in which the WTRU may be located. The SRSp configurations may (e.g., may also) be associated with a validity time or a scheduled time, indicating the schedule for when the WTRU may start/stop using the SRSp configuration for SRSp transmissions.

The SRSp configurations may be associated with positioning areas and scheduled times, which may (e.g., may also) be associated with the trajectory of the WTRU. The WTRU may receive the preconfigured SRSp configurations (e.g., in this case) from the network (e.g., serving gNB). The WTRU may select an SRSp configuration from the pre-configurations based on the positioning area where the WTRU may be located and/or the associated scheduled time. The WTRU may (e.g., may also) receive one or more SRSp configurations (e.g., possibly for use during a low power operation (e.g., power saving mode or in an INACTIVE/IDLE state/mode/operation)), which may be associated with achieving a different positioning QoS (e.g., accuracy achievable based on measurements made by the TRPs/gNBs) in different positioning areas and/or within a positioning area. The WTRU in a positioning area may select an SRSp configuration based on one or more of: the SRSp configuration which may be associated with the positioning area, a sub-area within the positioning area, or a positioning accuracy level expected to be achieved.

For determining the positioning area/sub-area where the WTRU may be located, the WTRU may (e.g., initially) receive/detect, via an SIB/SSB/PBCH, the IDs of one or more cells/TRP/gNBs (e.g., which may be in proximity with the WTRU and associated with the positioning area). The WTRU may estimate the WTRU location and determine the corresponding positioning area and associated SRSp configuration to apply based on an operation in the estimation mode (e.g., prediction, sensor measurement, tracking trajectory, etc.). The WTRU may determine the SRSp configuration to apply if the accuracy/error of the WTRU location in the positioning area is determined based on the estimation mode operation being greater than/less than one or more threshold values.

For determining whether an expected positioning QoS level may be achievable with the SRSp transmitted by the WTRU and/or measurements made by the corresponding TRPs/gNBs, the WTRU may perform measurements on DL signals (e.g., DL-PRS, CSI-RS, SSB, TRS, RS in spatial/QCL relation with SRSp). The measurements on the DL signals may determine the quality of radio links (e.g., RSRP measurements, number of multipaths, LOS/NLOS indication) corresponding to one or more TRPs/gNBs associated with the positioning area where the WTRU may be located. The association/assistance information related to the DL-signal may be received by the WTRU in the SIB, LPP signaling, or AS layer signaling (e.g., RRC, MAC CE, DCI). The association/assistance information may be in spatial relation with SRSp and/or transmitted from the TRP/gNB to which the WTRU intends to transmit SRSp. The WTRU may select the SRSp configurations based on the quality of the radio link. The WTRU may select a low bandwidth SRSp configuration if the RSRP of the corresponding DL signal (e.g., which may be measured by the WTRU) is greater than a threshold value. The WTRU may select a high bandwidth SRSp configuration if the RSRP of the corresponding DL signal (e.g., which may be measured by the WTRU) is less than a threshold value. The selection of different SRSp configurations based on the quality of associated DL-signals may enable achieving different and/or consistent level(s) of positioning accuracy during SRSp transmissions.

The WTRU may determine the SRSp configuration to apply for achieving an expected positioning QoS level based on an operation in the estimation mode (e.g., prediction, sensor measurement, tracking trajectory, etc.). The WTRU may use a low bandwidth, low periodicity SRSp configuration for transmitting an SRSp in UL. The WTRU may (e.g., may then) determine the accuracy/error of the WTRU location (e.g., determined using estimation mode) based on indications received from the network (e.g., in LPP messages, paging, RRC messages, MAC CE, DCI, etc.), which may indicate the information on the WTRU location determined via SRSp measurements in the network. The WTRU may (e.g., may then) determine a high bandwidth, high periodicity SRSp configuration to use for transmitting the SRSp and/or for achieving a positioning accuracy level. The WTRU may (e.g., may then) determine a high bandwidth, high periodicity SRSp configuration based on the whether the error/accuracy achieved with the low bandwidth, low periodicity SRSp configuration is greater than or less than one or more threshold values.

The WTRU may (e.g., may also) change the SRSp configurations to apply based on the change in the WTRU mobility state (e.g., from stationary to first (low) speed level, from first speed level to second speed level). The WTRU may use a first SRSp configuration (e.g., high periodicity SRSp configuration) if changing from a stationary mobility state to a low-speed mobility state for determining (e.g., ensuring) that the WTRU location may be determined with high accuracy if measuring the SRSp transmitted by the WTRU at the network. The WTRU may use a second SRSp configuration (e.g., low periodicity SRSp configuration), if the mobility state remains stable (e.g., within a speed range or within one or more threshold values). The WTRU may use the second SRSp configuration for maintaining positioning accuracy level and/or for power savings. If changing from first to second SRSp configuration, the WTRU may send an indication to the network (e.g., in an LPP message, an RRC, an MAC CE, a UCI, etc.) to activate measurements of SRSp transmitted by the WTRU.

Examples of a WTRU performing UL-based LPHAP based on location dependent configurations and/or resources are provided herein. The WTRU may determine the SRSp resources are used for performing SRSp transmissions (e.g., based on location-dependent configurations/resources for UL positioning). The SRSp configurations and/or resources accessed by the WTRU may be associated with one or more positioning areas. The positioning areas (e.g., each positioning area) may include one or more cells/TRPs/gNBs. The WTRU may use one or more SRSp configurations (e.g., periodic, aperiodic, semi-persistent), if located within an associated positioning area and/or if detecting at least one TRP/gNB (e.g., reception of PCI/cell ID and/or RSRP of radio link is above a threshold) in the positioning area. The location dependent SRSp configurations for LPHAP, including a set of resources and a subset of the resources indicated for activation/deactivation of the SRSp configurations, may be received by the WTRU in one or more of the following: an RRC CONNECTED state; an RRC release message (e.g., in SuspendConfig message), a SDT DL message; an SIB, or a paging message.

For the RRC CONNECTED state, the WTRU may receive the SRSp configuration(s) when sending a request for positioning service (e.g., via an LPP/LCS request or anRRC request) to a serving gNB if in CONNECTED state and/or if transitioning to a low power operation (e.g., an INACTIVE/IDLE state). The WTRU may receive information on the positioning areas where the SRSp configurations may be valid. The received SRSp configurations may be stored and used by WRTU ofdetecting an associated positioning area. For the RRCRelease message (e.g., in SuspendConfig message), the WTRU may receive the SRSp configuration(s) if releasing the WTRU to the low power operation (e.g., the INACTIVE or IDLE state). The SDT DL message may include a DL RRC message that may use DL-SDT random access resources associated with SDT (e.g., in Msg B, when using 2-step RACH procedure or Msg 4, when using 4-step RACH procedure). The SIB may include an SIB broadcast message (e.g., posSIB). The paging message may be received by the WTRU from one or more TRPs/gNBs in a positioning area (e.g., along with the WTRU ID).

The WTRU may receive (e.g., in addition to the SRSp configurations), one or more validity conditions and/or events associated with the SRSp for indicating: whether the received and/or stored SRSp configurations are valid; and/or when/where the SRSp configurations may be used/released. The validity conditions and/or events associated with the SRSp configurations may include one or more of the following: a timer, a RSRP change, or a validity area.

For the timer, a timer (e.g., TA timer) may be associated with a cell/TRP or positioning area (e.g., including multiple cells/TRPs). The timer may be used for indicating when the SRSp configuration may be activated/deactivated. A WTRU preconfigured with an SRSp configuration may activate the SRSp configuration for transmitting SRSp when a TA timer is configured and/or set (e.g., when under coverage of a cell and/or positioning area). The WTRU may deactivate the SRSp transmission when the TA timer expires. The WTRU may retain the SRSp configuration without releasing for subsequent use or release the SRSp configuration when the TA timer expires, possibly based on an explicit indication received from the network or detection of an implicit indication (e.g., via the duration configured for the TA timer).

For the RSRP change, the SRSp configuration(s) may be activated/deactivated/released by WTRU if the RSRP measured on a DL-signal (e.g., RS) received from one or more TRPs in a positioning area (e.g., which may be in spatial relation with the SRSp), is less than or greater than one or more threshold values. In examples: i) the WTRU may activate the SRSp configuration if the RSRP is less than a first threshold value; ii) the WTRU may deactivate the SRSp configuration if the RSRP is greater than a first threshold value and less than a second threshold value; and iii) the WTRU may release the SRSp configuration if the RSRP is greater than the second threshold value.

For the validity area, the SRSp configuration(s) may be activated/deactivated/released by the WTRU if entering/leaving a positioning area including the coverage of one or more cells/TRPs/gNBs. The WTRU may activate the SRSp configuration if detecting a first TRP in a positioning area and deactivate/release the SRSp configuration if detecting a second TRP in the same/different positioning area.

The SRSp configurations may be received by a WTRU from a serving gNB using any of the approaches discussed herein (e.g., after establishing RRC connection) or a non-serving gNB (e.g., without establishing RRC connection). In the case of a non-serving gNB, which may be located in a positioning area where the WTRU may be located, the WTRU may indicate a request for the SRSp configuration and/or resources by sending an RACH message/preamble associated with the request. A WTRU (e.g., a WTRU preconfigured with one or more SRSp configurations) may send a request for activation/deactivation of an SRSp by sending an RACH message/preamble associated with the activation request (e.g., along with a WTRU ID and/or SRSp configuration ID).

Examples of the WTRU using common SRSp resources based on sensing are provided herein. Location-dependent SRSp configurations and/or resources may not be dedicated for a given WTRU and/or may be common to multiple WTRUs located in a positioning area. This may result in an interference if multiple WTRUs (e.g., possibly located in proximity) transmit an SRSp using the common SRSp resources at the same time. A WTRU may include (e.g., in this case) an identifier associated with the WTRU (e.g., a preamble/WTRU ID/RA-RNTI) and/or a request for transmitting SRSp in an UL message (e.g., an RACH, an RRC message sent in RACH-SDT) prior to transmitting the SRSp using common SRSp resources.

The WTRU may transmit the SRSp using common SRSp resources if receiving a DL-indication (e.g., in DL SDT) from a network acknowledging/activating the SRSp resources and/or an identifier possibly associated with the WTRU. The WTRU may include and/or scramble the identifier associated with the WTRU if transmitting the SRSp. The WTRU may initiate a sensing procedure and/or a listen-before-talk (LBT) procedure for determining whether the common SRSp resources are currently being using by other WTRUs in proximity. In examples, the WTRU may perform sensing/LBT for a configured time duration and/or measure the energy level (e.g., RSRP) over the SRSp resources. The WTRU may use the SRSp resources for a certain duration (e.g., channel occupancy time (COT) associated with SRSp configuration) if the measured energy level (e.g., average, peak) is less than a threshold over the sensing/LBT duration. The WTRU may wait (e.g., may otherwise wait) for a certain duration (e.g., over a random number of time slots, configured number of slots) before reinitiating the sensing/LBT procedure for accessing the common SRSp resources.

The common SRSp resources may be accessed by WTRU for determining (e.g., ensuring) certain positioning accuracy achieved (e.g., if the TRP/gNBs perform measurements of an SRSp transmitted by the WTRU). The positioning accuracy levels (e.g., in this case) may be associated with different priority values, which may be used by the WTRU for accessing the common SRSp resources. The use of such priority values may result in using the SRSp resources with different COTs during SRSp transmissions. The WTRU intending to achieve a high accuracy level may access the resources with a first priority (e.g., high value) and/or use the SRSp resources with a first COT (e.g., long duration) during SRSp transmission. The WTRU intending to achieve a mid-level accuracy level may access the resources with a second priority (e.g., low value) and/or use the SRSp resources with a second COT (e.g., short duration) during SRSp transmission. The association between the SRSp resources, priority values, and/or COT values may be received by WTRU as assistance information/dynamic indications from the network (e.g., via an LPP message, an RRC message, an SIB, an MAC CE, a DCI, etc.).

Examples are provided herein of a WTRU changing/switching between SRSp configurations for supporting UL-based LPHAP based on a detection of triggering events. The WTRU may change from using a first SRSp configuration (e.g., high periodicity) to a second SRSp configuration (e.g., low periodicity) based on the detection of one or more triggering event/conditions (e.g., change in WTRU mobility states, reception of DL indication, etc.).

Examples may be include the following. The WTRU may receive configuration information including one or more SRSp configurations, including at least resources in a first SRSp configuration (e.g., high periodicity, low Tx duration, high bandwidth) and a second SRSp configuration (e.g. low periodicity, high Tx duration, low bandwidth). The configuration information may include SRSp Tx occasions (e.g., T0, T1, T2 . . . ) for transmitting the SRSp, where each time occasion (Ti) may be associated with the same or different SRSp configuration. In examples, T0 may be associated with the first SRSp configuration and T1 may be associated with the second SRSp configuration. The configuration information may include a SRSp Tx update/interruption duration D. In examples, a Tx update duration may refer to the duration in which the WTRU may not perform a transmission of the SRSp and/or may change from a first SRSp configuration to a second SRSp configuration.

The WTRU may receive the configuration information if in an RRC CONNECTED state (e.g., as a pre-configuration), in an RRC INACTIVE state (e.g., via RRCRelease message in SuspendConfig), or in an RRC IDLE state (e.g., via RACH/initial access message during initial access procedure, paging message). The configuration received during the CONNECTED or the INACTIVE state may be used and/or activated if operating in INACTIVE and/or IDLE state. The WTRU may transition or may be transitioned by network into INACTIVE or IDLE state (e.g., after receiving the configuration information when operating in CONNECTED/INACTIVE state).

When a first triggering event is detected (e.g., change in mobility state, reception of DL indication) for initiating SRSp transmission, a WTRU may start a first timer (e.g., for a configured time period). The first timer may run for a certain duration spanning next Tx occasion-current Tx occasion (e.g., T1−T0). When a first triggering event is detected (e.g., change in mobility state, reception of DL indication) for initiating an SRSp transmission, a WTRU may select an SRSp configuration associated with the current SRSp Tx occasion. In examples, the WTRU may select a first SRSp configuration (e.g., high periodicity) when the current SRSp Tx occasion is T0, and the WTRU may select the second SRSp configuration (e.g., low periodicity) when the current SRSp Tx occasion is greater than T0. When a first triggering event is detected (e.g., change in mobility state, reception of DL indication) for initiating an SRSp transmission, the WTRU may send an indication to the network (e.g., gNB/base station), indicating the start of SRSp transmission, when the current Tx occasion is T0. In examples, if the WTRU is in the INACTIVE state, the WTRU may send the indication in an SDT using RACH or CG resources associated with an SDT. In examples, when the WTRU is in an IDLE state, the WTRU may send the indication in an initial access/RACH message (e.g., RRCRequest, RRCSystemInformation Request, RRCReconfiguration Request, or a RACH/RRC message associated with positioning). In examples, the WTRU may send the indication when in IDLE in a RACH occasion (e.g., possibly associated with positioning). When sending the indication in INACTIVE/IDLE, the WTRU may include a flag/info and/or use resources associated with low power positioning, such that the WTRU may not be transitioned to the CONNECTED state. In examples, the WTRU may send the indication to network when transitioning to the CONNECTED state, possibly for non-positioning or positioning related causes.

If a first triggering event is detected (e.g., change in mobility state, reception of DL indication) for initiating an SRSp transmission, the WTRU may receive an indication from the network (e.g., in an LPP, an RRC, an MAC CE, a DCI, etc.), possibly confirming/activating the transmission of SRSp using the selected SRSp configuration. In examples, if the WTRU is in INACTIVE (e.g., an INACTIVE state/mode/operation), the WTRU may receive the indication in DL-SDT message (e.g., via an activated SDT configuration, DL-SDT RACH response, SPS-SDT, RRCRelease). In examples, if the WTRU is in IDLE (e.g., an IDLE state/mode/operation), the WTRU may receive the indication in an RRC message (e.g., RRCSetup, RRCReconfiguration) or a RACH response message. In examples, the WTRU may receive the indication in an updated SIB, which may be accessed by the WTRU after a certain configured time duration (e.g., expiration of timer) when sending the indication to the network. If a first triggering event is detected (e.g., change in mobility state, reception of DL indication) for initiating SRSp transmission, the WTRU may transmit an SRSp using resources in the selected SRSp configuration.

If a first triggering event is detected (e.g., change in mobility state, reception of DL indication) for initiating SRSp transmission and if a second event is detected (e.g., change in mobility state), the WTRU may stop the first timer and transmission of the SRSp. The WTRU may start a second timer (e.g., for a configured time period) for a duration of D when detecting a second event. If the second event is a semi-static event (e.g., WTRU receives periodic data in DL) and/or the second event ends before the expiration of the second timer, the WTRU may restart the first timer and/or restart the transmission of SRSp using the current SRSp configuration (e.g., SRSp configuration associated with closest SRSp Tx occasion). If the second event is a dynamic event (e.g., reception of high priority/URLLC data, change in trajectory/mobility state) and/or the second event ends after the expiration of the second timer, the WTRU may reset the first timer (e.g., to T0). The WTRU may send an indication to the network, indicating the reset of timer and/or the start of the SRSp transmission. The WTRU may (e.g., may then) transmit the SRSp using resources in the SRSp configuration associated with the Tx time occasion (e.g., reset time T0). If the second event corresponds to aborting transmission (e.g., reception of DL indication indicating stop SRSp transmission), the WTRU may stop the first timer and transmission of SRSp. If the second event is not detected, the WTRU may stop transmitting the SRSp at the expiration of the first timer (e.g., possibly for a configured time duration associated with INACTIVE/IDLE time, until the start of the next Tx occasion).

Examples are provided herein of a WTRU transmitting an SRSp based detection of locations in a preconfigured positioning area. The WTRU may transmit the SRSp at one or more locations associated with preconfigured positioning area (e.g., coverage area of a set of TRPs/gNBs) using an SRSp configuration associated with the positioning area. The WTRU may select an SRSp configuration from a set of preconfigured SRSp configurations based on the positioning area where the WTRU may be located and expected positioning QoS (e.g., accuracy) to be achieved with measurements at the TRPs in the positioning area. If an expected accuracy requirement is unable to be met at the TRPs, the WTRU may use the exceptional SRSp configuration (e.g., high BW SRSp configuration) associated with at least some of the TRPs that may meet the expected positioning QoS.

A WTRU may receive configuration information (e.g., in RRC CONNECTED/INACTIVE/IDLE state), including one or more of the following: one or more SRSp configurations, including at least resources in a low bandwidth SRSp configuration and a high bandwidth SRSp configuration (e.g., exceptional SRSp configuration); scheduled time occasions (e.g., T1, T2, . . . , Ti) at which the WTRU is expected to transmit SRSp; one or more sets of TRPs (e.g., cell IDs) in a positioning area, where each set of TRPs may be associated with an SRSp configuration (e.g., the TRPs in a set may be configured by an LMF to make measurements of SRSp transmitted by the WTRU at different time occasions); or threshold values for minimum/maximum number of TRPs that may be needed for meeting a positioning accuracy requirement.

The WTRU may transition or may be transitioned by the network for operating in a low power operation (e.g., INACTIVE/IDLE state/mode/operation) (e.g., after receiving the configuration information). The WTRU may perform measurements on DL-signals (e.g., TRS/SSB/PRS/CSI-RS) for detecting one or more TRPs and for determining the radio conditions associated with the detected TRPs (e.g., RSRP measurements of RS which may be in spatial relation with SRSp). The WTRU may perform the measurements at least the following time occasions: before Ti, close to time Ti, at Ti.

If the detected one or more TRPs match with a configured set of TRPs (e.g., the IDs of the detected set of TRPs and the IDs of the configured set of TRPs are the same or differ by a count which may be less than a threshold count), and if the number of detected TRPs with good RSRP (e.g., RSRP measured is greater than an RSRP threshold) are greater than the threshold for minimum number of TRPs, a WTRU may select the low bandwidth SRSp configuration associated with the detected TRPs. The WTRU may (e.g., may then) transmit the SRSp using resources in the low bandwidth SRSp configuration at the scheduled time occasion Ti. If the detected one or more TRPs match with a configured set of TRPs (e.g., the IDs of the detected set of TRPs and the IDs of the configured set of TRPs are the same or differ by a count which may be less than a threshold count), and if the number of detected TRPs with good RSRP is less than the threshold for minimum number of TRPs, the WTRU may determine a high bandwidth SRSp configuration (e.g., exceptional SRSp configuration) associated with detected TRPs with good RSRP, (e.g., possibly based on reception of a positioning SIB or preconfigured in WTRU). The WTRU may send an indication to the gNB (e.g., the WTRU may send indication via RACH-SDT/CG-SDT if operating in an RRC INACTIVE state and the WTRU may send an indication via a RACH/initial access message/RRCRequest or in RACH occasion associated with positioning message when operating in RRC IDLE state), indicating the IDs of the detected TRPs. The WTRU may request to activate the high bandwidth SRSp configuration. The WTRU may transmit an SRSp using resources in the high bandwidth SRSp configuration (e.g., possibly after receiving an activation indication from the gNB). In examples, the WTRU may receive the indication from the network in a DL-SDT message if operating in the INACTIVE state. In examples, the WTRU may receive the indication in an RACH response/RRCSetup/SIB update message if operating in the IDLE state.

If the detected TRPs do not match with a configured set of TRPs (e.g., the IDs of the detected set of TRPs and the IDs of the configured set of TRPs differ by a count that may be greater than a threshold count), the WTRU may send an indication to a gNB to request for an updated SRSp configuration. The WTRU may transmit the updated SRSp using resources in the updated SRSp configuration (e.g., after receiving information on the updated SRSp configuration from the gNB).

Examples are provided herein of a WTRU transmitting an SRSp based detection of Tx scheduled time occasions and triggering events. The WTRU may transmit an SRSp at scheduled time occasions using SRSp configurations associated with the time occasions. The differences in duration between each time occasion may be an absolute preconfigured value or variable relative value (e.g., in this case), which may depend on the previous time occasion and/or the type of an event detected by the WTRU. If detecting an event (e.g., the WTRU deviating from an expected trajectory, or measurements made on a spatial relation RS is below a RSRP threshold), the WTRU may use an alternative SRSp configuration for improving accuracy.

Examples may include the following. The WTRU may receive configuration information, including one or more of the following: one or more SRSp configurations, including at least resources in a low bandwidth SRSp configuration and a high bandwidth SRSp configuration (e.g., high BW and/or non-contiguous for achieving high accuracy); scheduled time occasions (e.g., T0, T1, T2, . . . ) at which WTRU may be expected to transmit SRSp; or an SRSp Tx time duration D.

At a scheduled time occasion (e.g., a first scheduled time occasion (e.g., T0), the WTRU may transmit an SRSp using resources from the low bandwidth SRSp configuration. If a triggering event is detected by WTRU (e.g., the WTRU receives low accuracy indication from the network, there is a change in mobility state or trajectory), the WTRU may stop SRSp transmission using the low bandwidth SRSp configuration and/or start a timer which may run for a duration D. The WTRU may send an indication to the network (e.g., gNB, LMF) for requesting to activate the high bandwidth SRSp configuration. The WTRU may transmit the SRSp using resources from the high bandwidth SRSp configuration until the expiration of the timer (e.g., after receiving an activation/acknowledgement message from the network).

If the triggering event ends before the expiration of the timer, the WTRU may stop the SRSp transmission using the high bandwidth SRSp configuration when the event ends. If the triggering event ends after expiration of the timer, and/or before start of the second scheduled time occasion (e.g., T1), the WTRU may stop the SRSp transmission using the high bandwidth SRSp configuration at the expiration of the timer. If the triggering event ends after the start of a subsequent scheduled time occasion (e.g., after T1), the WTRU may stop the SRSp transmission using the high bandwidth SRSp configuration at the expiration of the timer. The WTRU may start the SRSp transmission using the high bandwidth SRSp configuration at the start of second scheduled time occasion (e.g., T1). The WTRU may (e.g., may also) start the timer for a duration D. The WTRU may stop SRSp transmission using the high bandwidth SRSp configuration when the event ends and/or when the timer expires. The WTRU may restart the SRSp transmission using resources from low bandwidth SRSp configuration until expiration of timer (e.g., if the event ends before the timer expires). If a triggering event is not detected, the WTRU may stop the SRSp transmission using the low bandwidth SRSp configuration at end of the SRSp Tx time duration D.

As the time progresses (e.g., for time occasions greater than Tn, where n>0), the WTRU may gradually decrease the density of the time/frequency resources in an SRSp configuration during SRSp transmission. The WTRU (e.g., in this case) may receive the scheduled Tx time occasions (e.g., T0, T1, T2) for an SRSp transmission and/or SRSp configurations associated with each timing. The WTRU may start a timer at the first Tx time occasion. When an event is detected (e.g., WTRU received a DL signal/indication between T0 and T1) the WTRU may reset the timer (e.g., to T0) when the processing time duration for processing the event (e.g., associated with the received DL signal/indication) is greater than a threshold value. The WTRU (e.g., on the other hand) may continue with the transmission at the next Tx time occasion, when the processing time duration for processing the event is less than a threshold value. The WTRU may be configured with a SRSp transmission pattern (e.g., a transmission of SRSp at preconfigured timing, and a preconfigured time and/or frequency density). The WTRU may (e.g., may also) be configured with a time window (e.g., configured with start/end time, duration) from the network (e.g., LMF, gNB) during which the WTRU transmits the preconfigured SRSp transmission.

If there is a dynamic event (e.g., an event scheduled by DCI, MAC-CE, cancellation of SRSp transmission, the WTRU unable to transmit SRSp) that may result in the WTRU from stopping an SRSp transmission, the WTRU may pause the SRSp transmission and restart the transmission after the event (e.g., if the WTRU is configured to transmit an SRSp with a time density or periodicity N1 during the initial transmission and an SRSp with a time density or periodicity N2 after the initial transmission). The WTRU may transmit (e.g., after the restart), an SRSp with density N1. If the WTRU is preconfigured with a pattern of SRSp transmission, the WTRU may determine to restart the transmission pattern or continue the transmission of SRSp after the event (e.g., the WTRU may be configured to transmit SRSp with time density N1 during the initial transmission and SRSp with time density N2 after the initial transmission and if the event occurs after the initial transmission, the WTRU may determine to transmit SRSp with density N2 after the event) based on at least one of the following conditions: (i) the WTRU may restart the transmission pattern if the duration of the dynamic event is greater than a threshold duration (e.g., if the duration is less than or equal to the threshold duration, the WTRU may continue the transmission after the event); or (ii) the WTRU may continue with the transmission if the event is semi-static (e.g., periodic reception of DL/UL signals, monitoring SSB and/or DL signals/channels, events that are configured by an RRC or an LPP, etc.).

The WTRU may determine to terminate the transmission at the end of the configured time window. The WTRU may receive the configuration from the network via a DCI, an MAC-CE, an RRC, or an LPP message. The WTRU may terminate the SRSp transmission if the WTRU is configured to make a transition to an RRC_CONNECTED from an RRC_INACTIVE mode.

The WTRU may select a positioning area specific SRSp configuration based on the positioning area where the WTRU is located. The WTRU in an INACTIVE state (e.g., INACTIVE operation) may select a positioning area specific SRSp configuration for performing SRSp transmissions based on the cell associated with the positioning area where the WTRU is located (e.g., based on cell ID detected by WTRU). If the WTRU is located in a cell associated with a first positioning area (e.g., default positioning area), the WTRU may transmit an SRSp using a SRSp configuration of the first positioning area (e.g., a default SRSp configuration). If the WTRU is located in a cell outside of the first positioning area (e.g., outside the default positioning area), the WTRU may send a request to a network to activate a preconfigured SRSp configuration associated with the positioning area outside of the first positioning area (e.g., a second positioning area).

In examples, the WTRU may be configured to perform at least one of the following. The WTRU may receive configuration information (e.g., in a RRCReconfig message when the WTRU is in an RRC CONNECTED operation/state or in an RRCRelease message when the WTRU is in a low power operation (e.g., INACTIVE operation/state or idle operation/state) or transitioning from CONNECTED to INACTIVE), for example, from a base station in a first cell. The configuration information may indicate different SRSp configurations associated with different positioning areas, for example, a first SRSp configuration for a first positioning area and a second SRSp configuration for a second positioning area. The configuration information may indicate different cell ID sets associated with the different positioning areas, for example, a first cell ID set for a first positioning area and a second cell ID set for a second positioning area. The WTRU may transmit a first SRSp using a first (e.g., default) SRSp configuration (e.g., performed during the low power operation (e.g., based on receiving the RRCRelease message) and before detecting the second cell). The WTRU may transmit the first SRSp using the first SRSp configuration based on detecting a cell ID that is in a first cell ID set. The WTRU may select (e.g., detect) a second cell. The WTRU may determine the positioning area where the WTRU is located (e.g., based on a received/determined cell ID associated with the second cell. The WTRU may, if the detected second cell ID is in a first (e.g., default) positioning area, transmit a SRSp (e.g., in the second cell) using a first (e.g., default) SRSp configuration. The WTRU may, if the detected second cell ID is not in the first (e.g., default) positioning area, determine a second positioning area that the WTRU is in based on the detected second cell ID being in the second cell ID set and second cell ID set being associated with (e.g., included within) the second positioning area (e.g., determined from the configuration information/first association information). The WTRU may (e.g., based on the determination that the WTRU is in the second positioning area) determine the SRSp configuration (e.g., a second SRSp configuration) to use in the second positioning area based on the SRSp configuration (e.g., the second SRSp configuration) being associated with the second positioning area (e.g., determined from the configuration information/second association information). The WTRU may transmit an indication to the second cell to request to activate the SRSp configuration (e.g., the second SRSp configuration) associated with the second positioning area. The WTRU may receive an activation indication of the requested (e.g., second) SRSp configuration (e.g., indicating the ID of the SRSp configuration to be activated), a third SRSp configuration (e.g., different than the requested second SRSp configuration) or an activation indication of a third SRS configuration (e.g., in RRCResume message, RRCReconfig message, or MAC CE) from the second cell. The WTRU may transmit a SRSp using a SRSp configuration activated or indicated by the second cell.

The configuration information received from the base station may include at least one of the following. The configuration information may include a first (e.g., default) SRSp configuration (e.g., which may be activated) associated with a first positioning area. The configuration information may include a set of one or more SRSp configurations for positioning areas other than the first positioning area (e.g., the configuration information may include an SRSp configuration for a second positioning area, another SRSp configuration for a third positioning area, etc.) The configurations in the set of one or more SRSp configurations may be deactivated (e.g., at a time associated with reception of the configuration information). The configuration information may include a first (e.g., default) positioning area (e.g., which may be, may include, or may be associated with an area ID) (e.g., associated with the first SRSp configuration) and a first cell ID set in the first (e.g., default) positioning area (e.g., cell ID(s) of cell(s) in the first positioning area). The configuration information may include first association information indicating an association between positioning areas (e.g., which may be, may include, or may be associated with area IDs) and cell ID sets (e.g., which may include the second cell ID set being associated with a second positioning area). The configuration information may include second association information indicating an association between positioning areas (e.g., which may be, may include, or may be associated with area IDs) and a SRSp configurations (e.g., which may be, may include, or may be associated with configuration IDs) (e.g., which may include the second positioning area being associated with a second SRSp configuration).

For the WTRU selecting the second cell, the WTRU may (re) select the second cell if the WTRU moves from the first cell to the second cell (e.g., the WTRU may select the second cell if the WTRU detects a cell ID of the second cell).

For the WTRU determining the positioning area where the WTRU is located (e.g., where the second cell is located), the WTRU may determine the positioning area based on the detected second cell ID (e.g., PCI) in the SSB received from the second cell. In examples, the WTRU may determine the second cell is located in the second positioning area based on the detected second cell ID being in the second cell ID set associated with the second positioning area.

For the WTRU transmitting an indication to the second cell to request to activate the SRSp configuration (e.g., the second SRSp configuration) associated with the second positioning area (e.g., if the detected second cell ID is not in the default positioning area), the WTRU may transmit the indication in a RRCResumeRequest message possibly using SDT resources (e.g., RACH-SDT, CG-SDT). The ResumeRequest message may include a cause value/indication, indicating a request to activate an SRSp configuration without transitioning to a CONNECTED state. For the WTRU transmitting an indication to the second cell to request to activate the SRSp configuration associated with the second positioning area (e.g., if the detected second cell ID is not in the default positioning area), the WTRU may send the ID of the SRSp configuration associated with the positioning area where the WTRU may be located (e.g., the second positioning area). The WTRU may transmit in the indication or in another indication request to deactivate the first (e.g., default) SRSp configuration.

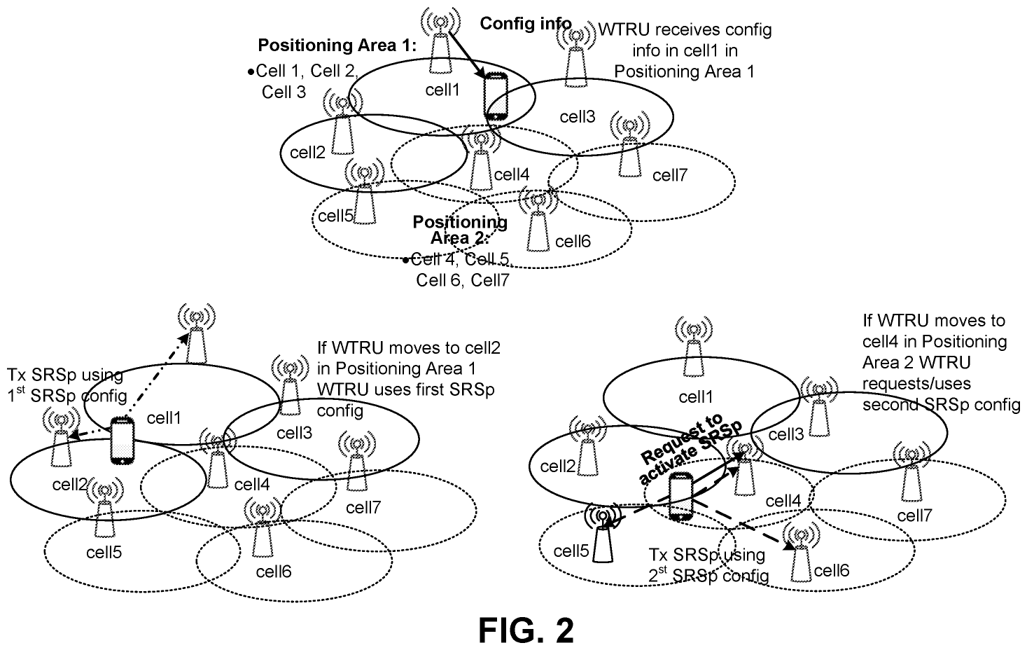

FIG. 2 illustrates a WTRU in a low power operation (e.g., an INACTIVE state) selecting a positioning area specific SRSp configuration for performing a SRSp transmission. The WTRU may select the positioning area specific SRSp configuration for performing the SRSp transmission based on the cell associated with the positioning area where the WTRU is located (e.g., based on cell ID detected by the WTRU). For example, if the WTRU is located or performs cell (re) selection in a cell (e.g., cell 2) associated with a first (e.g., default) positioning area, the WTRU may transmit a SRSp transmission using a first (e.g., default) SRSp configuration. For example, if the WTRU is located or performs cell (re) selection in a cell outside of the default positioning area (e.g., cell 4), the WTRU may send a request to a network to activate a (e.g., preconfigured) second SRSp configuration associated with a second positioning area.

The WTRU may send a request to update a validity condition of a SRSp configuration. The WTRU in a low power operation (e.g., an INACTIVE state) may send an indication to a network to update a validity condition (e.g., TA timer) associated with a SRSp configuration if a configured positioning event is detected (e.g., detection of an updated cell ID due to cell reselection or mobility). In examples, the WTRU may be configured to perform at least one of the following. The WTRU may receive configuration information (e.g., in RRCRelease message) including at least one of an SRSp configuration (e.g., a first SRSp configuration), a validity condition (e.g., TA timer associated with SRSp configuration), or a positioning event (e.g., detection of updated cell/TRP ID). The WTRU may transmit a SRSp using the SRSp configuration (e.g., the first SRSp configuration). The WTRU may, if a validity condition is not expired when detecting an updated TRP/cell ID (e.g., outside of positioning area), send an indication to a gNB indicating a request to extend a validity condition (e.g., in a RRC message or a MAC CE using SDT resource), receive an indication from a gNB indicating an extension of a validity condition (e.g., in a RRC message or a DL MAC CE), and/or transmit a SRSp using a SRSp configuration (e.g., a second SRSp configuration) in an existing and/or a updated cell. The WTRU may, if a validity condition is expired when detecting an updated TRP/cell ID (e.g., outside of positioning area), release the SRSp configuration (e.g., first SRSp configuration), send an indication to a gNB for a request for an updated (e.g., second) SRSp configuration (e.g., using SDT resource), receive the updated (e.g., second) SRSp configuration from a gNB, and/or transmit a SRSp using the updated (e.g., second) SRSp configuration.

The WTRU may select a SRSp configuration based on detectable TRPs. The WTRU may determine a set of one or more TRPs and SRSp configuration to use for meeting a positioning measurement accuracy requirement based on a number of TRPs detected with RSRP measurement of the SSB/RS received from the TRPs that are above an RSRP threshold. In examples, the WTRU may be configured to perform at least one of the following. The WTRU may receive configuration information, including at least one of a first (e.g., default) SRSp configuration (e.g., low density) and second SRSp configuration (e.g., high density), a TRP count threshold (e.g., a minimum number of TRPs detectable for meeting an accuracy requirement), or a RSRP threshold value. The WTRU may perform RSRP measurements of SSB/RS received from detected TRPs. The WTRU may, if the number of detected TRPs with RSRP above the RSRP threshold value is greater than the TRP count threshold, select the first SRSp configuration (e.g., low density) and/or transmit a SRSp using first (e.g., default) SRSp configuration. The WTRU may, if the number of detected TRPs with RSRP above the RSRP threshold value is less than the TRP count threshold, select the second (e.g., updated) SRSp configuration (e.g., high density), send an indication to a gNB (e.g., in a RRC message or a MAC CE using a SDT resource) to request to activate the second (e.g., updated) SRSp configuration, and/or transmit a SRSp using the second (e.g., updated) SRSp configuration if receiving an activation indication.

The WTRU may select a SRSp configuration based on an expected measurement accuracy in the positioning area where the WTRU is located. The WTRU in a low power operation (e.g., an INACTIVE state) may select a SRSp configuration based on an expected measurement accuracy in the positioning area where the WTRU is located. In examples, the WTRU may be configured to perform at least one of the following. The WTRU may receive configuration information (e.g., in a RRCRelease message) including at least one of a first (e.g., default) SRSp configuration (e.g., low density), a second (e.g., new) SRSp configuration (e.g., high density), or an RSRP threshold. The WTRU may perform RSRP measurements of SSB/RS received from TRPs. The WTRU may, if RSRP measurements are above the RSRP threshold, transmit an indication to a gNB (e.g., via a RRC message or a MAC CE using SDT resource) to request to activate the first SRSp configuration (e.g., low density) and/or transmit a SRSp using resources in the first SRSp configuration (e.g., possibly if receiving an activation indication and SRSp activation time window). The WTRU may, if RSRP measurements are below the RSRP threshold, transmit an indication to a gNB (e.g., via a RRC message or a MAC CE using SDT resource) to request for activating the second (e.g., updated) SRSp configuration (e.g., high density), transmit a SRSp using resources in the second (e.g., updated) SRSp configuration (e.g., possibly if receiving an activation indication and SRSp activation time window). The WTRU may transmit a deactivation indication to a gNB to terminate or release the first SRSp configuration (e.g., after the activation time window expires).

Examples for supporting positioning with Mobile Terminated Small Data Transmission (MT-SDT) are provided herein. A WTRU may be configured with MT-SDT for supporting positioning in a low power operation (e.g., a power saving state or an INACTIVE/IDLE state/mode/operation).

A WTRU may be configured with configurations and/or resources associated with MT-SDT for supporting at least one of the following if in a low power operation (e.g., an RRC INACTIVE/IDLE state): DL-based; UL-based; DL&UL based positioning, or RAT-independent positioning examples (e.g., any RAT-independent positioning examples (e.g., GNSS)). MT-SDT may refer to any procedures, configurations, and/or functionalities that may be supported by a WTRU and/or a network for DL receptions using SDT resources (e.g., RA-SDT, CG-SDT). Such DL reception, if supporting MT-SDT, may include at least one of one of the following if transitioning (e.g., before and/or after transitioning) to an RRC INACTIVE/IDLE state: data/control messages; assistance data; configuration information; or any LPP/LCS messages. In examples, an MT-SDT may include at least one of the following that the WTRU may receiving in the INACTIVE/IDLE state: any of the measurement configurations; PRS; or other reference signals (e.g., TRS, CSI-RS). The WTRU may receive (e.g., in the case of positioning) at least one of the following if operating in the INACTIVE/IDLE state (e.g., possibly after MT-SDT is triggered/activated).: DL data/control messages (e.g., LPP/LCS messages, activation/deactivation indications); or a PRS. The activation or deactivation command may be associated with a measurement gap or a PRS processing window for processing the measurements made on PRS.

In examples, MT-SDT may be configured along with MO-SDT, where both the MO-SDT and the MT-SDT may be configured in a WTRU at the same time (e.g., via RRCRelease) or the MT-SDT may be activated if the MO-SDT is activated. In examples, the MT-SDT may be configured and/or activated independent of the MO-SDT. In examples, the MT-SDT may be triggered and/or activated (e.g., explicitly triggered/activated) if the WTRU receives the configurations and/or indications (e.g., any of the configurations and/or indications) associated with activation of the MT-SDT. In examples, the MT-SDT may be activated/triggered (e.g., implicitly activated/triggered) when the WTRU receives at least one of: DL data/control messages (e.g., paging message); or a PRS if in the INACTIVE state. The WTRU may receive (e.g., in both cases) at least one of: DL data/control messages; or a PRS via MT-SDT if (e.g., after) the MT-SDT is activated/triggered (e.g., explicitly or implicitly).

The WTRU may be (pre) configured with one or more MT-SDT configurations and/or triggers for using MT-SDT by the network (e.g., serving base station/cell or LMF) via one or more of the following: RRC messages; reciprocity with MO-SDT; paging messages; or WTRU-initiated indications/requests.

For RRC messages, the WTRU may receive the configurations associated with MT-SDT if transitioning to the low power operation (e.g., RRC INACTIVE state) in RRC release message(s) (e.g., with suspend configuration). The WTRU may receive the MT-SDT configurations via RRC reconfiguration message(s) and/or RRC resume message(s) (e.g., possibly when in the INACTIVE state). If receiving RRC reconfiguration/RRC resume messages for the MT-SDT, the WTRU may receive an indication/flag indicating to remain in the low power operation (e.g., INACTIVE state). In examples, the WTRU may receive a paging message, which may include MT-SDT configurations in the RRC reconfiguration/RRC resume message received (e.g., along with the paging message). In examples, the WTRU may receive a paging message (e.g., followed by) RRC reconfiguration/RRC resume message(s) (e.g., which may include MT-SDT configurations). The WTRU may receive MT-SDT configurations via an RRC reconfiguration if in the RRC CONNECTED state. MT-SDT configurations in the WTRU may (e.g., may then) be activated if receiving (e.g., after receiving) an activation indication via an RRC release message and/or a paging message.

For reciprocity with MO-SDT, if the WTRU is configured with MO-SDT configurations (e.g., via a RRC Release message) and/or if MO-SDT configurations are triggered (e.g., based on first/initial transmission performed by the WTRU with a MO-SDT resource), the WTRU may use all or a subset of the configurations associated with the MO-SDT for the MT-SDT. In examples, if triggering MO-SDT (e.g., when WTRU performs first/initial transmission with MO-SDT resource), the WTRU may receive the configuration for MT-SDT or an activation/deactivation indication of MT-SDT (e.g., possibly via DL messages/signaling (e.g., in an RRC, an MAC CE, or a DCI).

For paging messages, the WTRU may receive MT-SDT configurations or indications to activate/deactivate preconfigured MT-SDT configurations, if receiving one or more paging messages. In examples, the paging messages received by WTRU may include the WTRU ID (e.g., I-RNTI, paging I-RNTI) within the DCI and/or a flag/indication possibly indicating the presence of an MT-SDT configuration. If detecting such DCI, the WTRU may demodulate and/or decode the corresponding PDSCH to extract an MT-SDT configuration in the paging message. In examples, if receiving (e.g., after receiving) the paging message in one or more paging occasions, which may indicate the presence of an MT-SDT configuration for the WTRU, the WTRU may initiate a RACH procedure by transmitting a RACH preamble. The WTRU may (e.g., may then) receive an MT-SDT configuration or an activation/deactivation indication for a preconfigured MT-SDT via an RA-SDT or initial access messages (e.g., Msg 2, Msg 4 or Msg B). In examples, if configured with SDT resources (e.g., CG-SDT) and if receiving (e.g., after receiving) a paging message, the WTRU may transmit a request message (e.g., RRC request or RRC resume) for at least one of: initiating an SDT; for requesting an MT-SDT configuration; or for (de) activating preconfigured MT-SDT. The WTRU may (e.g., may then) receive the MT-SDT configurations or (de) activation indication for the preconfigured MT-SDT in DL (e.g., via RRC, MAC CE, DCI). Such UL and DL messages may be transmitted/received by the WTRU using SDT resources while remaining in the low power operation (e.g., INACTIVE state). The WTRU may receive an indication in a paging message (e.g., an RRC or PDCCH signaling) that indicates to the WTRU to transition to a different RRC state or to perform an RRC resume procedure (e.g., possibly associated). A WTRU configured with a DL SDT may monitor a subset of paging occasions (or a subset of P-RNTIs). Such a partition may be configured and may be associated with a reception of a DL SDT or an initiated DL SDT procedure.

For WTRU-initiated indications/requests, the WTRU may receive MT-SDT configurations for receiving data/control messages in DL if in the low power operation (e.g., INACTIVE state) if sending (e.g., any of) the indications or request messages in the RRC CONNECTED or RRC INACTIVE state (e.g., in SDT). Such indications and/or request messages may include one or more of the following: assistance information for configuring a DRX (e.g., cycle duration, on-duration, offset start time associated with PRS measurement); a request for configuring/activating a measurement gap; or requests/assistance information for configuring configured grants/SPS (e.g., payload size and/or periodicity for receiving periodic assistance data/LPP messages from LMF). The WTRU may receive configurations related to at least one of: an MT-SDT (e.g., DL CG resource, applicable DL SDT RBs, other positioning (e.g., aforementioned positioning) related configurations, etc.); part of RRC release message; part of a paging message; or via broadcast signaling. The WTRU may request for such configuration, or a subset thereof, if performing cell re-selection, gNB re-selection, crossing a RAN notification area, or a tracking area.

The WTRU may activate resources configured for a UL SDT (e.g., a CG-SDT resource) if receiving an indication to initiate a DL SDT procedure (e.g., possibly conditioned on receiving a TA command or conditioned on having UL timing synchronization (e.g., TA timer or CG-TAT running)). In examples, the WTRU may activate a CG-SDT resource if receiving (e.g., following the reception of) a paging indication/trigger indicating a DL SDT procedure initiation. The WTRU may start the CG-TAT if receiving a paging indication/trigger indicating a DL SDT procedure initiation.

Configuration information associated with MT-SDT may be received by a WTRU using at least one of the following: radio bearer configurations; radio resource configurations; validity conditions; timing advance (TA)/TA timer configurations; RSRP difference thresholds configurations; positioning related configurations; priority values; traffic related configurations; or DRX configurations.

For radio bearer configurations, the WTRU may be configured with one or more DRBs and/or SRBs (e.g., SRB0, SRB1, SRB2, SRB3) (e.g., which may possibly be used after MT-SDT is triggered/activated). The WTRU may be configured with one or more parameters associated with DRBs/SRBs for an MT-SDT, including: parameters associated with the sublayers/entities of the DRB/SRBs such as a service data adaptation protocol (SDAP), PDCP (e.g., ROCH, encryption/ciphering, integrity protection, packet duplication); RLC mode (e.g., AM, UM, TM); MAC entities (e.g., priority, logical channel priority (LCP), logical channel (LCH) restrictions, data volume threshold for a TB), or a physical layer (PHY).

For radio resource configurations, the WTRU may be configured with one or more RA-SDT and/or CG-SDT configurations. The WTRU may use the RA-SDT and/or CG-SDT configurations for receiving DL data (e.g., in PDSCH), if (e.g., after) an MT-SDT is activated. The RA-SDT configurations may include at least parameters corresponding to the IDs, payload size, data volume, message types (e.g., Msg 2, Msg 4, Msg B), etc. applicable if the MT-SDT is triggered. The CG-SDT configurations may include at least parameters corresponding to IDs, start offset time slot, periodicity, payload size, etc. that may be used by WTRU if the MT-SDT is triggered. The WTRU may be configured with one or more resource configurations for receiving data/control messages and/or PRS if (e.g., after) the MT-SDT is triggered and/or activated, including at least one of BWPs (e.g., initial, non-initial), carriers, beams, or time/frequency resource pools.

For validity conditions, the WTRU may be configured with one or more validity conditions associated with the validity of MT-SDT configurations. Such validity conditions may include area validity (e.g., list of cells/cell IDs) and/or time validity (e.g., time duration/window), where the corresponding MT-SDT configurations may be assumed by the WTRU to be valid for usage. In examples, the validity condition indicating the validity of an MT-SDT configuration may include a reception count. The WTRU may be configured (e.g., in this case) with N number of receptions associated with MT-SDT. A MT-SDT configuration may be activated during the first reception and/or may be deactivated after the nth reception, for example.

For timing advance (TA)/TA timer, the WTRU may be configured with a TA timer associated with a MT-SDT configuration that may be used for determining whether the MT-SDT is valid for usage. When the TA timer expires, the WTRU may stop/suspend using the associated MT-SDT configuration and/or may release the MT-SDT configuration. If receiving a TA command, the WTRU may restart the TA timer associated with the MT-SDT.

For RSRP difference thresholds, the WTRU may be configured with one or more RSRP difference thresholds associated with an MT-SDT configuration that may be used for determining whether the MT-SDT is valid for usage. In examples, if the RSRP difference measured between the DL signal that transitions the WTRU to the INACTIVE state (e.g., RRC release message) and another DL signal (e.g., any DL signal, possibly associated with MT-SDT) is greater or less than a threshold value, the WTRU may stop/suspend using the associated MT-SDT configuration and/or may release the MT-SDT configuration.

For positioning related configurations, the WTRU may be configured with one or more MT-SDT configurations associated with positioning. Such MT-SDT configurations may include the resources (e.g., CG-SDT, RA, SDT) and/or radio bearers (e.g., SRBs) for receiving at least one of: one or more positioning related messages (e.g., LPP/LCS messages; one or more (de) activation indications; or one or more positioning configurations (e.g., SRSp and/or PRS configs).

For priority values, the WTRU may receive priority values associated with one or more MT-SDT configurations. The WTRU may decide whether or which of the MT-SDT configurations to use for receiving the DL data (e.g., during a DRX cycle when in INACTIVE/IDLE state) (e.g., based on the associated priority values). The priority values may be associated with PRS resources configured for the WTRU. In examples, the WTRU may receive a priority level associated with a PRS processing window during which the WTRU may determine to process PRS based on the priority level. If the priority of PRS is low compared to other DL signals or channels, the WTRU may determine to postpone processing of the measurements made on PRS. If the priority level of PRS is higher than other DL signals or channels, the WTRU may determine to prioritize processing of the measurements made on PRS.

For traffic related configurations, the WTRU may be configured to receive data in a DL with different payload sizes via an MT-SDT. The WTRU may (e.g., may also) be (pre) configured with different MT-SDT configurations which may be associated with different payload sizes. The WTRU may select/use (e.g., in this case) a suitable MT-SDT configuration for receiving the DL data within a certain payload size, possibly based on an indication received from network (e.g., a paging message that may indicate the ID of MT-SDT configuration to use or information on payload size of DL data). In examples, the WTRU may be configured to receive periodic or semi-persistent data in a DL via the MT-SDT. The WTRU may be (pre) configured with different MT-SDT configurations which may be associated with different periodicity values. The WTRU may (e.g., may also) be configured with different parameters associated with receiving periodic/semi-persistent data via the MT-SDT (e.g., including start/stop offset time and time duration/window). The WTRU may select/use (e.g., in this case) a suitable MT-SDT configuration for receiving the DL data within certain periodicity (e.g., possibly based on an indication received from network (e.g., a paging message)).

For DRX configurations, the WTRU may be configured with one or more DRX configurations if in a low power operation (e.g., an INACTIVE/IDLE mode/state). Such DRX configurations may be aligned with the MT-SDT resources/configurations (e.g., the periodicity of ON/active time of DRX may be aligned with periodicity of CG-SDT of MT-SDT). The WTRU may (e.g., may also) be configured with different DRX parameters, including DRX cycle duration, ON duration, and inactivity timer, which may be aligned with MT-SDT resources for receiving DL data if in the INACTIVE/IDLE mode/state.

In examples, if initiating/activating the MT-SDT for a DL reception (e.g., first DL reception), the MT-SDT may remain active for another DL reception (e.g., further DL reception), for example, until an explicit (e.g., RRC reconfiguration message) or implicit indication (e.g., WTRU moves to a new cell, TA timer expires) is received from the network indicating deactivation of the MT-SDT configuration(s). The MT-SDT configuration(s) may be re-activated/restarted if receiving an indication associated with the MT-SDT (e.g., TA command) from the network. In examples, a configured and/or activated MT-SDT configuration may remain activated for further DL reception at least until an indication to release the MT-SDT configuration (e.g., RRC release) and/or an indication to transition from the RRC INACTIVE state to the RRC CONNECTED state (e.g., RRC resume request) is received from the network.

If receiving a DL SDT TB (e.g., after the reception of a DL SDT TB), the WTRU may monitor for reception of another (e.g., subsequent) DL SDT TB. A subsequent DL SDT TB may be received as a DL transmission (e.g., subsequent DL transmission) on a configured DL CG-SDT resource, an RA-SDT resource, or as a scheduled PDSCH DL assignment. The WTRU may monitor a PDCCH resource, a search space, or a CORSET for the reception of another (e.g., subsequent) DL SDT TB or assignment.

In examples, the WTRU may (e.g., may conditionally) monitor for another (e.g., subsequent) DL SDT if at least one of the following is met: a TB configured for DL SDT is multiplexed with the TB of the initial DL SDT; an RRC message is not present, multiplexed or not, with the initial DL SDT TB (e.g., an RRC release message); or the TB size of the initial DL SDT TB is less than or greater than a configured threshold.

Examples of a WTRU receiving indications/information on positioning via MT-SDT if in a low power operation (e.g., RRC INACTIVE/IDLE mode) are provided herein. The WTRU may receive one or more indications/messages associated with positioning (e.g., LCS/LPP messages) from the network (e.g., RAN and/or LMF) while operating in the RRC INACTIVE/IDLE mode. Such positioning messages may include at least one of those related to: an MT-LR; a deferred MT-LR; or MO-LR positioning services. The positioning messages/indications may be received by the WTRU via the MT-SDT (e.g., if the MT-SDT is initiated/running due to a previous DL SDT reception or UL SDT transmission). In examples, the reception of a positioning message/indication may trigger/activate a preconfigured MT-SDT configuration in the WTRU (e.g., if the MT-SDT is not initiated).

If configured with an MT-SDT and/or if a preconfigured MT-SDT configuration is activated, a WTRU may receive one or more of the following messages/indications/configurations related to positioning if in the INACTIVE/IDLE mode: LCS messages, LPP messages, or RAN-related configurations.

The LCS messages may include messages (e.g., any messages) related to MT-LR, deferred MT-LR, and MO-LR (e.g., positioning service request, ACK/NACK status confirmation, positioning report), which the WTRU may receive from network (e.g., base station, LMF, AMF, etc.)

The LPP messages may include one or more of: an LPP request for capability information; an LLP providing assistance data; or an LPP request for location information. For the LLP request for capability information, the WTRU may receive the request for supporting at least one of the positioning examples: DL-based; UL-based; or DL&UL based examples. For the LPP provide assistance data, the WTRU may receive one or more PRS and/or SRSp configurations for supporting at least one of the positioning examples (e.g., as described herein). Such configurations may be received in LPP assistance data message(s) and/or in RRC messages. The WTRU may (e.g., may also) receive assistance data (e.g., location info of TRPs/gNBs, beam direction, boresight angle, correction info) based on whether WTRU-based positioning or WTRU-assisted positioning is requested by the network. For an LPP request for location information, the WTRU may receive from a LMF the LPP message, possibly along with at least one of: a response time indicating the time duration for performing measurements, processing of the measurements, or reporting the results to network.

The RAN-related configurations may include at least one of: SRSp resources/configurations; activation/deactivation indications for SRSp/PRS configurations; measurement gap (MG) configurations; or correction information. For SRSp resources/configurations, the WTRU may receive at least one of: the SRSp configurations (e.g., aperiodic SRSp, semi-persistent SRSp, or periodic SRSp); or parameters associated with the SRSp configurations (e.g., IDs, start offset time slot, periodicity). Configuration information may be received in RRC messages (e.g., RRC release), MAC CE, and/or DCI. For SRSp configurations, the WTRU may be configured with activation/deactivation rules for determining when to start and stop SRSp transmissions if receiving (e.g., after receiving) the SRSp configurations. In examples, the WTRU may start transmission of an SRSp (e.g., using resources of semi-persistent or periodic SRSp configured) after (e.g., immediately after) receiving the associated SRSp configurations (e.g., without any explicit activation indication). The WTRU may stop SRSp transmission (e.g., for periodic or semi-persistent SRSp) when (e.g., any of) the validity conditions (e.g., TA, RSRP difference threshold) associated with MT-SDT or MO-SDT expire.

For activation/deactivation indications for SRSp/PRS configurations, the WTRU may start/stop the transmission of SRSp (e.g., semi-persistent SRSp or aperiodic SRSp) based on reception of explicit or implicit indication from the network. Such (de) activation indication may be received by WTRU via an MT-SDT in a RRC message, an MAC CE, or a DCI.

For measurement gap (MG) configurations, the WTRU may receive at least one of: configurations associated with an MG; or indications to activate/deactivate a preconfigured MG via the MT-SDT. Such MG related configurations and/or indications may be received by the WTRU if transmitting (e.g., after transmitting) a request for MG indication during the CONNECTED state or the INACTIVE state (e.g., via UL SDT). Such MG related configurations and/or indications received via the MT-SDT may be used for performing DL-PRS measurements if in the INACTIVE/IDLE state.

For the correction info, the WTRU may receive correction information such as a timing error group (TEG) via the MT-SDT. Such correction information may be received by a WTRU if transmitting (e.g., after transmitting) a request indication during the CONNECTED state or the INACTIVE state (e.g., via UL SDT). Such correction info may be used by the WTRU for determining the WTRU location if operating in a WTRU-based positioning mode.

The WTRU may receive the LPP request for WTRU capability information and/or LPP assistance data which may be piggybacked if receiving a LCS request via the MT-SDT. The WTRU may receive (e.g., in this case) one or more of the LPP messages (e.g., the LPP messages described herein), either in a single MT-SDT reception (e.g., single NAS/LPP message) or in multiple MT-SDT receptions (e.g., multiple NAS/LPP messages).

The reception of messages/indications (e.g., any of the messages/indications described herein) may result in initiating/activating an MT-SDT for a WTRU in the INACTIVE state if an MT-SDT is configured and/or not previously initiated in WTRU. In examples, if a MT-SDT is initiated/activated (e.g., after MT-SDT is initiated/activated), the WTRU may send a request message to the base station for changing/updating the activated MT-SDT configuration or a request for releasing the MT-SDT configuration (e.g., possibly when transitioning from the INACTIVE to the CONNECTED state). Such a request for changing and/or releasing the MT-SDT may be sent by the WTRU to the base station due to at least one of the following triggers: traffic/QoS requirements; DRX misalignment; or positioning requirements.

For traffic/QoS requirements, the WTRU may send the request indication for changing the MT-SDT for meeting certain QoS requirements (e.g., latency, data rate) if receiving data in a DL during the INACTIVE/IDLE state. The WTRU may (e.g., may also) send the request indication if detecting changes to QoS of data received in a DL (e.g., latency increases above/below a threshold, bit rate decreases above/below a threshold) during the INACTIVE/IDLE state.

For DRX misalignment, the WTRU may send the request indication for changing the MT-SDT if detecting misalignment (e.g., any misalignment) between data reception in a DL during the INACTIVE/IDLE state and the DRX configured in WTRU.

For the positioning requirements, the WTRU may send the request indication for changing the MT-SDT if detecting changes associated with positioning including at least one of: changes to positioning accuracy achievable; changes to PRS/SRSp configurations used; or changes to the MG configured in the WTRU for performing positioning measurements.

In examples, the WTRU may receive an activation/deactivation command for the transmission of SP-SRSp or related positioning measurement and reporting procedure during a DL SDT procedure (e.g., part of the PDSCH payload or part of MT-SDT configuration). The WTRU may activate/deactivate the transmission of SP-SRSp or related positioning measurement and reporting procedure if receiving a paging message, possibly associated with DL SDT or not (e.g., part of the paging message itself or indicated as part of the PDCCH scheduling the paging message). In examples, the WTRU may activate/deactivate the transmission of an SP-SRSp or a related positioning measurement and reporting procedure if receiving a PDCCH including the WTRU's P-RNTI or an ID of the WTRU (e.g., possibly if the paging message is associated with a DL SDT).

In examples, the WTRU may deactivate or activate an SP-SRSp or a related positioning measurement and reporting procedure if a configured timer expires. The WTRU may reset such a timer, if (e.g., each time) it receives a response or a DL transmission from the network (e.g., any DL transmission, such as a PRS, a DL SDT TB, or a PDCCH).

Examples of WTRU behaviors/actions associated with positioning based on whether an MT-SDT is configured and/or initiated are provided herein. In examples, the WTRU may determine the positioning examples that may be supported (e.g., DL-based, UL-based, DL&UL based, or MT-LR/deferred MT-LR) and/or indicated to network (e.g., to LMF) (e.g., possibly in the WTRU capability information) based on whether the MT-SDT and/or a MO-SDT is configured and/or activated in the WTRU. In examples, the WTRU may indicate that the WTRU supports the MT-LR and/or deferred the MT-LR positioning during a low power operation (e.g., INACTIVE state) if both the MO-SDT and the MT-SDT are configured and/or activated in the WTRU. In examples, the WTRU may indicate that the WTRU supports deferred (e.g., only deferred) MT-LR if the MO-SDT (e.g., only the MO-SDT) is configured and/or activated.

In examples, the WTRU may decide whether/which of the LPP messages to send to the network and/or which of the corresponding LPP messages may be received based on whether the MT-SDT is configured and/or activated. In examples, the WTRU may decide to send a request for assistance data to the network when the MT-SDT is configured and/or activated, since the WTRU may receive the corresponding LPP assistance data via the MT-SDT.

In examples, the WTRU may decide whether to perform PDCCH monitoring (e.g., possibly during an ON duration of DRX) if operating in the INACTIVE state for receiving paging messages or DL data (e.g., positioning information) based on whether the MT-SDT is configured and/or activated. In examples, if the WTRU sends an LCS/LPP request message (e.g., request for assistance data) to the network, the WTRU may assume corresponding DL data (e.g., LPP assistance data) is received by the WTRU. The WTRU may skip monitoring a PDCCH for receiving DL data (e.g., any DL data) in a PDSCH (e.g., if MT-SDT is not configured/activated).

In examples, the WTRU may determine whether to receive/skip DL messages (e.g., periodic LPP messages) associated with positioning based on the resources associated with the MT-SDT (e.g., RA-SDT, CG-SDT) configured in the WTRU. The WTRU may skip receiving certain DL data (e.g., if determining the payload sizes or the periodicity of the DL data expected to be received is not aligned with the resources associated with the configured and/or activated MT-SDT).

Examples of a WTRU determining and sending indications to the network on attributes of expected DL positioning information based on configured MT-SDTs are provided herein. The WTRU may determine and/or provide assistance information/indications to the network for ensuring that the DL data (e.g., possibly associated with positioning (e.g., LPP/LCS messages)) may be received with resources and/or configurations associated with an MT-SDT.

In examples, if the payload size of LCS/LPP messages (e.g., aperiodic or periodic LPP assistance data) expected to be received by the WTRU is relatively small, the WTRU may receive the LPP messages and perform PRS measurements while remaining in a low power operation (e.g., an INACTIVE state). It may be possible that the resources (e.g., CG-SDT, RA-SDT), periodicity, and/or data volume threshold (e.g., payload restrictions) associated with the MT-SDT configurations may not be sufficient and/or properly aligned with the time occasions if the DL LPP/LCS messages are received during the INACTIVE state. The WTRU may be transitioned (e.g., in this case) to the CONNECTED state for receiving the LPP/LCS messages (e.g., possibly resulting in additional latency or signaling overhead).

In examples, for receiving data with particular traffic characteristics via the MT-SDT, the WTRU may provide assistance information to the network (e.g., base station and/or LMF). The assistance information may be provided so that the MT-SDT may be configured and/or triggered with the awareness of the data expected to be received by the WTRU if in the INACTIVE state. The WTRU may provide assistance information to the network. The assistance information may include at least one of the following: traffic information or segmentation related information.

For traffic information, the WTRU may provide information on the expected payload sizes of data (e.g., average, min, max), periodicity (e.g., for periodic DL data), QoS requirements (e.g., latency, data rate, reliability), etc.

For segmentation related information, the WTRU may provide information/indication/flag on whether higher layer (e.g., LPP) segmentation is supported in DL and/or UL. Based on such information, the WTRU may receive one or more preconfigured MT-LR configurations and/or indications on which MT-LR configuration to activate/use if receiving the segmented packet data units (PDUs). The WTRU may (e.g., may also) provide information related to at least one of the following: IDs related to segmented PDUs; a number of segments expected in DL per LPP/LCS message/PDU; an expected/average payload size per segmented PDU; or a latency associated for delivering one or more segmented PDUs.

The WTRU may provide (e.g., may provide any of the) assistance information to the network periodically (e.g., with preconfigured periodicity) and/or when triggered by some events (e.g., if detecting a change in traffic, change in measurements, and/or mobility that may result in changing any of the existing MT-SDT configurations).

In examples, the WTRU may determine the attributes of positioning information to be received via the MT-SDT, including the payload size and/or periodicity of the expected positioning information (e.g., periodic assistance data). The attributes of the positioning information may be determined based on the configurations (e.g., periodic resources associated with CG-SDT or a data volume threshold) that may be associated with the MT-SDT (e.g., signaling radio bearers (SRBs) of the MT-SDT).

In examples, the WTRU may determine whether the positioning information (e.g., carried in a non-access stratum (NAS_message) is to be segmented into one or more segments. Such determination may be based on the data volume threshold configuration associated with the SRBs configured in the WTRU for receiving positioning information in the DL. The LMF may segment the positioning information (e.g., in this case) to different segments which may be smaller than or equal to the configured data volume threshold, such that segmented data may be delivered via the MT-SDT. In examples, the WTRU may determine the periodicity to be used by the network (e.g., LMF), if delivering periodic positioning information (e.g., periodic LPP assistance data, or periodic ACK/NACK status indication if the WTRU transmits periodic reports) based on the periodicity configured for the resources associated with MT-SDT (e.g., CG-SDT). In examples, the WTRU may determine the number of segments and/or payload sizes of segments (e.g., each segment) to be applied, if delivering the segmented positioning information based on the configured resources associated with the MT-SDT (e.g., CG-SDT). In examples, the WTRU may determine the number of segments to be applied by the LMF, if sending the segmented data in the DL based on a latency requirement associated with the positioning service configured in the WTRU and/or the expected latency for receiving the DL data using MT-SDT resources configured in the WTRU.

The WTRU may send an indication/request to the network (e.g., to LMF via LPP message) on the determined attributes of positioning information (e.g., periodicity, payload sizes, whether to segment or not, number of segments to be used) to be used if sending the positioning information in the DL. In examples, if determining the attributes of the positioning information expected in the DL, the WTRU may send an indication to the network (e.g., to the base station via RRC, MAC CE, UCI, possibly in the CONNECTED/INACTIVE state). The indication may request a MT-SDT (e.g., a new MT-SDT) or change/update an existing MT-SDT configuration, so that the MT-SDT configuration may be aligned with the expected reception of positioning information in the DL. In examples, if sending the indication to the network (e.g., to the base station via an RRC, an MAC CE, a UCI, possibly in the CONNECTED/INACTIVE state) on the determined attributes of the positioning information expected in the DL, the WTRU may receive a DRX configuration (e.g., new/updated DRX configuration) for usage during the INACTIVE/IDLE state that may be aligned with the MT-SDT and/or expected reception of positioning information in the DL.

Examples of the WTRU receiving positioning information in the DL based on a data volume threshold configured for an MT-SDT are provided herein. The WTRU in a low power operation (e.g., an INACTIVE state) may receive one or more types of positioning information (e.g., PSR/SRSp configurations and/or LPP messages) using an MT-SDT configuration for one or more SRBs based on the data volume threshold values associated with the SRBs. The different SRBs (e.g., SRB0, SRB1, SRB2, SRB3) may be configured in the WTRU (e.g., in this case) for carrying and/or delivering the positioning information using the MT-SDT. The different SRBs configured for the MT-SDT in the WTRU may be configured with one or more data volume threshold values associated with the different types of positioning information.

The data volume threshold may be used for resuming the SRBs (e.g., SRB2) configured for the MT-SDT if triggered by the arrival of higher layer indications (e.g., indicating the expected reception of positioning information). In examples, the WTRU may send an indication to network to request resuming and/or activating SRB2 for receiving RRC message(s) and/or NAS message(s) in the MT-SDT if the size of the expected positioning information (e.g., in NAS message) is less than or equal to the data volume threshold configured for the SRB2. The data volume threshold may be configured by the LMF or gNB. An approach (e.g., similar approach) used for receiving positioning information using SDT if the WTRU is in the INACTIVE state may (e.g., may also) be applicable when the WTRU is in the IDLE state.

In examples, the WTRU may be configured with one or more SRBs (e.g., which may be used for carrying and/or delivering positioning information via the MT-SDT) based on the size of the positioning information determined by the WTRU. The WTRU may be configured with a data volume threshold corresponding to the SRB(s) (e.g., in this case) based on an indication/information (e.g., assistance info) sent by the WTRU to the network. The indication/information may indicate the size of the positioning information to be carried or expected to be received using the MT-SDT. In examples, the WTRU may indicate to the serving gNB if sending an indication to the network (e.g., capability information, LCS/LPP message), the size of the positioning information (e.g., LPP assistance data) expected to be received in the DL if operating in the INACTIVE state. The WTRU may send the indication to the gNB on the size of the positioning information in an RRC message, an MAC CE, or a UCI, for example. The WTRU may send the indication to gNB if in the CONNECTED state or during or after transitioning to the INACTIVE state (e.g., via a UL SDT). If configured with the corresponding data volume threshold, the WTRU may (e.g., may then) receive the positioning information in the associated SRB (e.g., SRB2) using the MT-SDT.

In examples, the SRBs configured for MT-SDT (e.g., SRB1, SRB2) in the WTRU may be associated with different data volume thresholds per-SRB, where at a given time (e.g., any given time) at least one data volume threshold may be activated for the SRBs. The different data volume thresholds may be associated with a flag or an indicator, which may be used during triggering and/or activating the MT-SDT (e.g., via paging). In examples, a default data volume threshold may be activated and applicable if initially the SRB is configured for the MT-SDT. In examples, the WTRU may be configured with a default/first data volume threshold which may be aligned with the size of the expected NAS message carrying positioning information (e.g., an LPP message).

In examples, the data volume threshold may be dynamically changed and/or updated based on a triggering of the MT-SDT. The WTRU may determine (e.g., initially determine) if the expected positioning information is less than the default/first data volume threshold (e.g., possibly based on the positioning message (e.g., LPP/LCS message) or type of the message generated and transmitted by the WTRU in the UL). If the expected positioning information is determined to be higher than a first data volume threshold and/or less than or equal to a second configured data volume threshold, the WTRU may trigger activation of the MT-SDT. The activation of the MT-SDT may be triggered by sending a resume request (e.g., in UL-SDT using RA-SDT or CG-SDT resources) to the network including an indicator/flag associated with the second data volume threshold. The WTRU may (e.g., may then) receive the positioning indication if receiving a resume message (e.g., RRC resume in MT-SDT) indicating the activation of the second data volume threshold. The WTRU may (e.g., in this case) continue receiving one or more positioning information messages (e.g., periodic assistance data) if the second data volume threshold remains activated and/or not deactivated by the network. The data volume threshold (e.g., the aforementioned data volume threshold) may be configured by the LMF or the gNB.

Examples of the WTRU sending indications/information on an RRC state and/or MO-SDT/MT-SDT configurations to an LMF for supporting associated positioning procedures are provided herein. The WTRU may send information indicating a WTRU RAN configuration. The information indicating the WTRU RAN configuration may include at least one of: its RRC state; MO-SDT and/or MT-SDT configurations; or positioning configurations to be applied in the RRC state. The information indicating the WTRU RAN configuration may be sent to the LMF for supporting position procedures associated with the RRC state/configurations. In examples, the WTRU may send an indication to the LMF if transitioning from the CONNECTED to the low power operation (e.g., INACTIVE state) such that the WTRU may receive the assistance data (e.g., PRS configurations). The assistance data may be applied if the WTRU operates in the INACTIVE state. The WTRU may send the indication (e.g., aforementioned indication) to the LMF via an LPP, an RRC, an MAC CE or a UCI.

In examples, the WTRU may receive positioning information including one or more PRS configurations (e.g., optimized for low power operation) or an update to the QoS requirements associated to positioning, including positioning accuracy and/or latency. The WTRU may receive the positioning information based on the information sent by the WTRU to the network on its RRC state, MT-SDT, and MO-SDT configurations. The positioning information received by the WTRU (e.g., in this case) may enable the WTRU to flexibly balance the trade-offs in terms of achieving high positioning accuracy, high device efficiency (e.g., low power consumption), and/or low latency positioning, for example.

In examples, the WTRU may receive assistance data. The assistance data may include one or more PRS configurations, to be used for making measurements if operating in the INACTIVE/IDLE state. The PRS configurations may be based on the indication sent by the WTRU to the network on a current and/or a future RRC state, an MT-SDT, and MO-SDT configurations. The WTRU may receive the PRS configuration to be used if the WTRU is operating in a particular RRC state and/or MO-SDT/MT-SDT configurations. The WTRU may use a first PRS configuration when configured with a first combination of MO-SDT and MT-SDT configurations (e.g., with high data volume threshold/payload sizes in UL/DL). The WTRU may (e.g., may also) use a second PRS configuration if configured with a second combination of MO-SDT and MT-SDT configurations (e.g., with low data volume threshold/payload sizes in UL/DL). The use of the first PRS configuration may result in a shorter measurement duration and lower latency. The use of the second PRS configuration may result in low power operation and longer measurement duration/latency.

In examples, if the WTRU is configured with SDT for sending data (e.g., positioning information) if in the INACTIVE state, the WTRU may receive a measurement reporting configuration from the network (e.g., an LMF) indicating one or parameters to be used if sending the measurement reports when in the INACTIVE state. The parameters associated with measurement report configuration (e.g., which may be received by WTRU) may include at least one of: the type of measurements to be reported (e.g., rich/simplified reporting); the amount of measurements to be reported (e.g., size of each measurement report); or the periodicity of reporting. Whether reporting is simplified or rich may be determined by the number of paths (e.g., additional paths) the WTRU reports measurements.

The WTRU may report (e.g., in a simplified report) the PRS measurements related to a path (e.g., the main path). In a rich report, the WTRU may report the PRS measurements related to the main path and N additional paths, where N may be configured by the LMF. The parameters for measurement report configuration may be received from the LMF based on the information sent by the WTRU on the data volume threshold configured for SDT (e.g., in one or more SRBs/DRBs). The WTRU may be configured to send measurement reports (e.g., simplified measurement reports), for example, with reduced granularity, in the INACTIVE state, based on the awareness at the LMF of the (lower) data volume threshold configured for SDT.

The WTRU may send the MT-SDT configuration information for INACTIVE/IDLE mode operation, including the information on the SRB/DRBs (e.g., SRB2) configured for the MT-SDT and/or the DRX configurations, to the LMF. The WTRU may send information (e.g., the aforementioned information) to the LMF via an LPP, an RRC, an MAC CE, or a UCI. The configuration information for INACTIVE mode operation may be sent by the WTRU to the LMF, if receiving at least one of: LPP/LCS messages; receiving new/updated MT-SDT/MO-SDT configurations; receiving a new/updated DRX configuration; or if the WTRU RRC state is changed.

Examples of the WTRU receiving indication(s) for using an MT-SDT configuration during mobility are provided herein. The WTRU may receive an MT-SDT configuration (e.g., a new or updated MT-SDT configuration) if moving to a cell/gNB (e.g., new cell/gNB), such that the WTRU may continue to receive (e.g., any of) the DL messages/configurations and perform PRS measurements and/or SRSp transmissions while remaining in RRC INACTIVE/IDLE state. The WTRU may be configured (e.g., initially configured) with the MT-SDT (e.g., in a RRCRelease message) for receiving positioning information and/or SRSp configurations (e.g., periodically) from a source cell/TRP. The WTRU may (e.g., may also) be configured (e.g., along with the MT-SDT configuration) by the source cell/TRP with one or more validity conditions, including a TA timer, validity time duration, and/or validity area (e.g., list of cell IDs). The one or more validity conditions may be used by the WTRU for determining whether the MT-SDT configurations are valid for usage if in the RRC INACTIVE/IDLE state.

If the WTRU moves to a cell (e.g., new cell), where the cell ID (e.g., new cell ID) may be within the validity area, the WTRU may use (e.g., may continue using) the MT-SDT configuration for receiving positioning information and/or configurations via the MT-SDT while in the RRC INACTIVE/IDLE state. In examples, a WTRU which may be configured with a semi-persistent SRSp, may receive the activation indication (e.g., MAC CE) from the source/first cell for activating an SRSp transmission. A WTRU, which may be configured with semi-persistent SRSp, may (e.g., may also) receive the deactivation indication (e.g., MAC CE) to stop the SRSp transmission from another/second cell. The activation and/or deactivation indications may be received via the MT-SDT (e.g., in this case, possibly due to the MT-SDT being configured to be valid across different cells).

If one or more validity conditions expire, where the WTRU may move to a new/target cell/TRP which may be outside of the validity area, the WTRU may send an indication to network (e.g., in RRC Resume request via initial access messages or SDT). The WTRU may (e.g., may also) send in the indication in the ID, the cause value indicating expiration/release of the previous MT-SDT configuration and/or a request for an MT-SDT configuration (e.g., new MT-SDT configuration). If fetching the WTRU context from the source cell/TRP, the target cell/TRP may determine whether the WTRU may be allocated/activated with a new MT-SDT configuration or the WTRU may continue using the previous MT-SDT configuration (e.g., possibly based on the identifiers and/or request sent by the WTRU).

In response to the indication sent by WTRU due to the expiration of the previous MT-SDT configuration, the WTRU may receive from the target cell/TRP one or more of the following: a RRCResume message (e.g., in Msg B or Msg 4) indicating to use a new MT-SDT configuration; a RRCRelease message (e.g., in Msg B or Msg 4) indicating to release the previous MT-SDT configuration and/or use a new MT-SDT configuration; or a RRCRelease message indicating to continue using the previous MT-SDT configuration

The RRCResume message and/or RRCRelease message may include the parameters associated with the new MT-SDT configuration (e.g., RA-SDT and/or CG-SDT resources) or may include an activation indication (e.g., ID of configuration) to activate a preconfigured MT-SDT configuration.

Examples of the WTRU receiving assistance data/configurations for positioning via the MT-SDT during mobility are provided herein. The WTRU may receive assistance data/configurations, which may possibly include one or more positioning configurations (e.g., PRS/SRSp configurations) via the MT-SDT if moving to a cell/TRP (e.g., new cell/TRP) while continuing to operate in the RRC INACTIVE/IDLE state. The WTRU may (e.g., may initially) receive the assistance data, either via broadcast, dedicated RRC signaling, or LPP messages, if triggering of the LCS/LPP procedure for positioning while in the coverage of a source cell/TRP. The WTRU may receive the assistance data in dedicated signaling while in the CONNECTED state (e.g., in this case), if transitioning to the low power operation (e.g., RRC INACTIVE/IDLE state) (e.g., in an RRCRelease message) or if in the low power operation (e.g., INACTIVE/IDLE state) (e.g., via the MT-SDT).

The WTRU may receive validity conditions (e.g., via validity timer/timer duration or a list of cell IDs in validity area) associated with the assistance data, which may be used for determining whether the assistance data (e.g., PRS/SRSp configurations) are valid for usage when in the RRC INACTIVE/IDLE state. In examples, the WTRU validity conditions for assistance data may be associated with the validity conditions of the MT-SDT configuration. If the MT-SDT configuration is determined to be valid/invalid (e.g., in this case), the WTRU may assume the assistance data may (e.g., may also) be valid/invalid. The WTRU may assume the MT-SDT configuration to be valid/invalid, if the WTRU determines the assistance data to be valid/invalid.

The WTRU may receive configuration/rules for determining whether to send a request for assistance data (e.g., new assistance data) in dedicated NAS/RRC signaling, a UL SDT, or to acquire the assistance data (e.g., new assistance data) via broadcast RRC signaling (e.g., SIB) (e.g., possibly including on-demand SIB). In examples, the configuration/rules may indicate a first set including one or more cell/TRP IDs in which the WTRU may be allowed to send the request for (e.g., new) assistance data (e.g., PRS/SRSp configurations). The configuration/rules may (e.g., may also) indicate a second set including of one or more cell/TRP IDs, which may overlap at least in part with the first set, from which the WTRU may receive the assistance data (e.g., new assistance data) in the MT-SDT.

If the conditions/rules associated with sending a request are satisfied (e.g., new cell/TRP ID is outside of the validity area), the WTRU in the RRC INACTIVE state may send the request message (e.g., RRCResumeRequest message via SDT) for assistance data (e.g., new assistance data) for one or more (e.g., new) PRS and/or SRSp configurations. The WTRU may include in the indication, the identifiers associated with the WTRU (e.g., I-RNTI) and/or the previous assistance data (e.g., PRS/SRSp configuration IDs). The cell/TRP (e.g., new cell/TRP) may fetch the WTRU context from the source cell/TRP based on the WTRU ID and the request for assistance data (e.g., new assistance data) received from the WTRU. The WTRU may include in the indication, the cause value indicating the expiration, and/or a release of the previous assistance data/configurations for requesting the new assistance data. In response to the request, the WTRU may either receive at least one of: new assistance data (e.g., via the MT-SDT); an activation indication for a preconfigured assistance data (e.g., for a preconfigured PRS/SRSp configuration); or an indication for continuing to use the previous assistance data. The WTRU may receive the response indication in a RRCResume message, a RRCRelease message (e.g., in Msg B or Msg 4), or the MT-SDT.

Examples associated with supporting DL and UL-based LPHAP are provided herein. A WTRU may be configured to perform DL and UL based LPHAP (e.g., using multi-RTT positioning technique) based on a measurement of DL-PRS and/or a transmission of UL-SRSp in one or more RTT cycles if in a low power operation (e.g., an INACTIVE/IDLE state). DL and UL based positioning may include a first phase and a second phase. The first and second phases may include a DL-PRS reception and/or a measurement at the WTRU and UL-SRSp transmission from the WTRU to TRPs. In WTRU-assisted DL and UL based positioning, the WTRU may report the DL-PRS measurements (e.g., RSRP, PRS time-of-arrival (ToA), RSTD measurements) and/or the PRS reception and SRSp transmission timing difference measurements (e.g., WTRU Rx-Tx) to the network. The location of the WTRU, in the case of multi-RTT positioning, may be determined based on one or more of the following: the PRS measurements performed by WTRU; SRSp measurements performed by TRPs/gNBs; WTRU Rx-Tx measurements; or TRP/gNB Tx-Rx measurements. In DL and UL based LPHAP, the WTRU may apply and/or combine (e.g., any of) the techniques associated with DL-based and UL-based LPHAP (e.g., described herein). Such techniques may include one or more of the following: mitigating positioning errors in DL and UL based positioning; applying condition dependent configurations/resources; aligning DL-PRS transmissions and UL-SRSp receptions; applying intra-band resources for DL-PRS and UL-SRSp transmissions; or applying inter-band resources for DL-PRS and UL-SRSp transmissions.

For mitigating positioning errors in DL and UL based positioning the WTRU may switch from an estimation/prediction mode to a measurement mode for DL-based positioning in a first phase (e.g., DL-PRS measurements) if detecting a positioning error (e.g., any positioning errors) when performing UL-based positioning in a second phase (e.g., UL-SRSp transmission). In examples, the WTRU may switch between the estimation/prediction mode and the measurement mode UL-based positioning in a first phase if detecting positioning errors when performing DL-based positioning in a second phase. The WTRU may be configured by the network with one or more thresholds. The one or more thresholds may be associated with positioning errors for determining whether/when to switch between the measurement and the estimation mode. The WTRU may use information on the positioning error detected in the first phase to apply certain corrections in the second phase. In examples, if performing RSRP measurements of the DL-PRS received in the first phase and/or the RSRP measurements below a threshold value, the WTRU may perform an SRSp transmission in the second phase using a selected SRSp configuration (e.g., high Tx power, high repetition, high periodicity) that may result in improving measurement accuracy. Such scenarios may occur if the WTRU is located in a coverage limited area or areas with poor radio link quality. If the RSRP measurements of a PRS are above the threshold value, the WTRU may transmit an SRSp using an SRSp configuration (e.g., low Tx power, low repetition, low periodicity) that may result in improving power savings at the WTRU.

For applying condition-dependent configurations/resources, the WTRU may be preconfigured with PRS/SRSp resources/configurations. The PRS/SRSp resources/configurations may be dependent on the one or more cells/zones/areas where the WTRU is to be located or expected to move into. The WTRU may (e.g., in this case) use certain PRS/SRSp resources for UL and DL positioning if located in the cells/areas associated with the PRS/SRSp resources. The WTRU may be preconfigured with conditions and/or restrictions for using the PRS/SRSp resources. In examples, the WTRU may be configured with conditions associated with the radio link quality, including one or more of: RSRP, pathloss threshold (e.g., RSRP of PRS, SSB), or TA, for determining if the WTRU may use an SRSp configuration (e.g., after performing PRS measurements). The WTRU may (e.g., in this case) use a restricted set of SRSp resources if (e.g., only if) the RSRP of the PRS measurements are below a threshold.

For aligning DL-PRS transmissions and UL-SRSp receptions, the WTRU may be configured to use one or more time windows and/or DRX cycles. The one or more time windows and/or DRX cycles may be applied during an INACTIVE/IDLE state (e.g., such that the DL PRS receptions and/or UL SRSp transmissions may be performed within the time window/DRX cycle). Such alignment of the time windows/DRX cycles may allow the WTRU to minimize the number of wake up instances and maximize the sleep duration, such that both PRS measurements and SRSp transmissions may be performed by the WTRU over a short and/or aligned time window/DRX cycle. If performing such aligned PRS receptions and/or SRSp transmissions, the WTRU may perform one or more of the following: determine the aligned time window/DRX cycle (e.g., based on the PRS and/or SRSp configuration info); determine the PRS and/or SRSp configurations to apply based on a preconfigured time window/DRX cycle; send an indication to the network requesting for configuring and/or triggering the aligned time window/DRX cycle; or receive an indication from the network, indicating the configurating and/or triggering of a time window/DRX cycle for aligned DL and UL positioning.

For applying intra-band resources for DL-PRS and UL-SRSp transmissions, the WTRU may use DL-PRS resources and/or UL-SRSp resources. The DL-PRS resources and/or UL-SRSp resources may be associated with similar bands and/or resource pools during transmission and/or reception in an INACTIVE/IDLE state. The usage of a similar band within the same band/BWP may be intended for minimizing the amount of bandwidth the WTRU may be allowed to use during the INACTIVE/IDLE state and/or for minimizing power consumption in the WTRU. If performing a DL-PRS measurement and/or a UL-SRSp transmission in the INACTIVE/IDLE state, the WTRU may use the same/similar center frequency for the PRS and/or the SRSp. Such usage may improve power savings at the WTRU by avoiding retuning to a different center frequency if performing the SRSp transmission after performing PRS reception, or vice-versa.

If applying inter-band resources for DL-PRS and UL-SRSp transmissions, the WTRU may be configured with one or more FR2 bands for the PRS and the SRSp configurations/resources for performing DL and UL positioning. If the PRS measurements made by the WTRU indicate poor link quality or high pathloss (e.g., RSRP of PRS is below a threshold), the WTRU may (e.g., in this case) switch to using an SRSp configuration and/or resources in an FR1 band for mitigating link related issues. If switching to an SRSp configuration in an FR1 band, the WTRU may use lower Tx power during SRSp transmission. Such switching between FR2 and FR1 bands may be configured and/or applied by the WTRU if in coverage/power limited scenarios and/or if operating in the INACTIVE/IDLE state.

A WTRU may be configured to perform DL and UL positioning if in a low power operation (e.g., an INACTIVE/IDLE state) based on triggering events. In examples, a WTRU may be configured by a network to perform DL and UL (e.g., multi-RTT) positioning via DL-PRS measurements and via UL-SRSp transmissions to one or more TRPs if operating in the INACTIVE/IDLE state, based on detection of pre-configured positioning triggering events. Such positioning triggering events may include one or more of: a time event (e.g., expiration of a timer, a periodic event); an area event (e.g., an event triggered when entering into a new area/cell); or a mobility event (e.g., a change in speed, trajectory).

If the WTRU is in the INACTIVE state and/or if (e.g., if only) a MO-SDT is supported, the WTRU may trigger a SDT procedure at least twice for one or more the following: for sending the initial request message to a network (e.g., LMF) based on a detection of one or more events for triggering DL and UL based positioning or for sending the measurement report to the network (e.g., after performing PRS measurement (e.g., time of arrival of PRS, RSRP) and SRSp transmission). If the WTRU is in an IDLE state, the WTRU may perform an RACH to transition to a CONNECTED state or send UL data using a UL resource grant (e.g., received in Msg 2) or preconfigured UL resource (PUR) (e.g., at each time instance when the WTRU intends to send (e.g., any) request messages, indication, and/or report to the network). Such procedures in the INACTIVE/IDLE state may result in high signaling overhead, high latency, and/or high power consumption.

If operating in the INACTIVE/IDLE state, the WTRU may transmit the initial request message (e.g., for reporting positioning triggering event) in an initial access message (e.g., in Msg 1, Msg 3, Msg A, PRACH preamble) to the network (e.g., gNB). In examples, the initial access message may include an indication to forward the request to an LMF for initiating positioning procedure (e.g., for triggering DL and UL based positioning). In examples, the initial access message may allow the WTRU to send (e.g., quickly send) request messages/indications (e.g., any request messages/indications) to the network, and/or eliminate overhead for transmitting/receiving (e.g., additional) signaling (e.g., event report ACK/NACK feedback) or latency to transition to the CONNECTED state.

If sending the initial request message (e.g., via initial access message, and/or SDT), the WTRU may perform one or more of the following if in the INACTIVE/IDLE state: receive assistance data, use preconfigured assistance data, receive one or more SRSp configuration/resources for UL-SRSp transmission; or receive an indication to trigger PRS measurement and/or SRSp transmission.

For receiving assistance data, the assistance data may include of one or more PRS configurations/resources for DL-PRS measurements. Such assistance data may be received if the WTRU sends an indication in the initial request message requesting for assistance data. Such assistance data may be received if the pre-configured assistance data (e.g., any of the pre-configured assistance data) in the WTRU is no longer valid (e.g., due to timer expiration, validity area expiration).

For using preconfigured assistance data, the preconfigured assistance data may include (e.g., any of) PRS configurations and/or resources for DL-PRS measurements. Such preconfigured assistance data may be used by the WTRU if it is determined by the WTRU to be valid for usage during PRS measurements. Such preconfigured assistance data may be used by the WTRU if receiving an indication from a network. The indication from the network may indicate to use one or more preconfigured PRS configurations (e.g., configuration IDs).

For receiving one or more SRSp configurations/resources for UL-SRSp transmission, such SRSp configurations or an indication to use a preconfigured SRSp configuration (e.g., ID of SRSp configuration) may be received by the WTRU via an initial access message, an LPP message, an RRC message (e.g., using the MT-SDT), an MAC CE, or a DCI.

For receiving an indication to trigger a PRS measurement and/or SRSp transmission, such an indication may be received by the WTRU via an initial access message (e.g., Msg 2, Msg 4, Msg B) or the MT-SDT. Such an indication may include one or more of an LPP message (e.g., a request for location info, an event report ACK), an RRC message, an MAC CE, or a DCI. If the WTRU is configured with one or more types of SRSp, including aperiodic SRSp, semi-persistent SRSp and/or periodic SRSp, the WTRU may receive a triggering indication via a DCI, a MAC CE, a RRC, or a paging message (e.g., indicating the type of SRSp (e.g., ID).

PRS/SRSp configurations and/or indications/trigger messages may be received by the WTRU in a paging message or as part of a paging message. In examples, the WTRU may receive (e.g., in a paging message or during a paging occasion) an indication of the WTRU ID (e.g., P-RNTI) and/or an indication/trigger message for a SRSp transmission in the PDCCH. The WTRU may monitor for a PDCCH and/or a PDSCH to receive the SRSp/PRS configurations and/or indications/trigger messages in the paging message and/or in DL receptions (e.g., subsequent DL receptions). In examples, the DL receptions may include the MT-SDT. In examples, the WTRU may receive the PRS/SRSp configurations and/or indications/trigger messages in a wake-up signal (WUS).

If receiving the PRS/SRSp configurations and/or indications, the WTRU may perform DL-PRS measurements using the PRS configuration and/or UL-SRSp transmissions using the SRSp configurations. The WTRU may perform the measurement of the time difference between the reception of PRS and the transmission of SRSp (e.g., WTRU Rx-Tx difference). If performing a PRS measurement and/or a SRSp transmission, the WTRU may transmit the measurement report including the PRS measurements (e.g., time of arrival, RSRP), WTRU Rx-Tx difference measurements, etc. For transmitting the measurement report if in INACTIVE/IDLE state, the WTRU may send the report in an initial access message (e.g., Msg A, Msg 3) or trigger SDT procedure. In examples, the WTRU may send the report in Msg 5. In examples, the WTRU may determine to send a SRSp and a measurement report in the same message (e.g., Msg 3, Msg 5, Msg A).

The WTRU may determine to perform a round trip time (RTT) based positioning. The WTRU may be preconfigured to perform the RTT based positioning if a SSB RSRP is above the preconfigured threshold. The WTRU may measure the time of arrival of the SSB and send the corresponding Msg A preamble and measurement report in the message A. The measurement report may include a WTRU Rx-Tx difference, or a RSRP. The WTRU Rx-Tx difference may (e.g., in this case) be the difference between the time of arrival between the SSB and a transmission time of the corresponding preamble or SRSp.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
receive configuration information indicating a first sounding reference signal for positioning (SRSp) configuration associated with a first positioning area and a second SRSp configuration associated with a second positioning area, wherein the first positioning area is associated with a first set of cell IDs and the second positioning area is associated with a second set of cell IDs;
select an SRSp configuration, wherein the selected SRSp configuration is the first SRSp configuration or the second SRSp configuration, and wherein the selection is based on at least the first positioning area, the second positioning area, and a location of the WTRU; and
transmit an SRSp using the selected SRSp configuration.

17. The WTRU of claim 16, wherein the processor is further configured to:
deactivate the first SRSp configuration or the second SRSp configuration that is not selected.

18. The WTRU of claim 16, wherein the processor is further configured to:
determine whether a cell ID is in the first set of cell IDs or in the second set of cell IDs, wherein the selection of the SRSp configuration is further based on the determination of whether the cell ID is in the first set of cell IDs or in the second set of cell IDs.

19. The WTRU of claim 18, wherein:
the first SRSp configuration is selected if the cell ID is detected as being in the first set of cell IDs, and
the second SRSp configuration is selected if the cell ID is detected as being in the second set of cell IDs.

20. The WTRU of claim 16, wherein the processor is further configured to:
receive an RRC release message; and
based on receiving the RRC release message, transition to a low power operation, wherein the transmission of the SRSp is performed during the low power operation.

21. The WTRU of claim 20, wherein the low power operation is an inactive or idle operation.

22. The WTRU of claim 16, wherein the configuration information is received in an RRC reconfiguration message.

23. A method associated with a wireless transmit/receive unit (WTRU), the method comprising:
receiving configuration information indicating a first sounding reference signal for positioning (SRSp) configuration associated with a first positioning area and a second SRSp configuration associated with a second positioning area, wherein the first positioning area includes a first set of cell IDs and the second positioning area includes a second set of cell IDs;
selecting an SRSp configuration, wherein the selected SRSp configuration is the first SRSp configuration or the second SRSp configuration, and wherein the selection is based on at least the first positioning area, the second positioning area, and a location of the WTRU; and
transmitting an SRSp using the selected SRSp configuration.

24. The method of claim 23, further comprising:
deactivating the first SRSp configuration or the second SRSp configuration that is not selected.

25. The method of claim 23, further comprising:
determining whether a cell ID is in the first set of cell IDs or in the second set of cell IDs, wherein the selection of the SRSp configuration is further based on the determination of whether the cell ID is in the first set of cell IDs or in the second set of cell IDs.

26. The method of claim 25, wherein:
the first SRSp configuration is selected if the cell ID is detected as being in the first set of cell IDs, and
the second SRSp configuration is selected if the cell ID is detected as being in the second set of cell IDs.

27. The method of claim 23, further comprising:
receiving an RRC release message; and
based on receiving the RRC release message, transitioning to a low power operation, wherein the transmission of the SRSp is performed during the low power operation.

28. The method of claim 27, wherein the low power operation is an inactive or idle operation.

29. The method of claim 23, wherein the configuration information is received in an RRC reconfiguration message.
